(19) United States
(12) Patent Application Publication
(10) Pub. No.: US 2006/0245862 A1
(43) Pub. Date: Nov. 2, 2006

(54) Telescopic push arm, particularly for a load-receiving means

(76) Inventors: Rudolf Hansl, Linz (AT); Josef Reischl, Gunskirchen (AT)

Correspondence Address: WILLIAM COLLARD;COLLARD & ROE, P.C., 1077 NORTHERN BOULEVARD, ROSLYN, NY, 11576, US

(21) Appl. No.: 10/557,160

(22) PCT Filed: May 19, 2004
(86) PCT No.: PCT/AT04/00175

§ 371 Date: Jan. 12, 2006

(30) Foreign Application Priority Data
May 20, 2003 (AT) A 778/2003

(51) Int. Cl. B65G 1/00

(52) U.S. Cl. 414/281

(57) ABSTRACT

The invention relates to a telescopic push arm (11a, 11b) for a load-receiving means (9) mounted on a vertically adjustable lifting platform (8) of a conveying vehicle for storing an auxiliary loading means (1) in or removing it from a shelf storage (3b), with a support frame (14a, 14b) and a carriage (15a, 15b) adjustable relative to the latter, said carriage being provided with a servo-drive (50a to 50e) and/or sensor, whereby the servo-drive (50a to 50e) and/or the sensor are connected to an electrical interface (52) within the area of the support frame (14a, 14b) via a transmission means (20) for transmitting electrical energy and/or electrical signals. The transmission means (20) for transmitting electrical energy and/or electrical signals is formed by a sliding-line arrangement and a sliding-body arrangement (16, 18), or transmitting and/or receiving units, whereby for transmitting energy and/or signals from the interface (52) to the servo-drive (50a to 50e) and/or sensor (51), an electrical sliding contact (17) is formed between the sliding-line arrangement and the sliding-body arrangement (16, 18), or an electromagnet field is generated between two transmitting and/or receiving units.

The invention relates to a telescopic push arm for a load-receiving means for stockpiling an auxiliary loading means in and removing it from a shelf storage system, as well as to a load-receiving means, as specified in the introductory parts of claims 1, 12, 26 and 41.

A telescopic push arm of this type of a load-receiving device for storing a block-shaped auxiliary loading means in a shelf storage facility and removing it from the latter, is known from US 2003/0185656 A1. Said telescopic push arm is comprised of a support frame, a center intermediate carriage and an outer carriage, said carriages being adjustable relative to the support frame and to one another. The outer carriage is provided with driving elements, which are adapted for pivoting transversely to the longitudinal expanse of the telescopic push arm, and are each coupled to a servo-drive (actuator), and sensors are associated with said driving elements for monitoring their operating positions. The sensors and/or actuators are arranged on the outer carriage. Said sensors and/or actuators are provided with electrical energy by means of electrically conductive connections such as, for example cable lines. Such cable lines are laid in energy chains which, starting from an interface (supply source) arranged within the area of the support frame, lead to the sensors an/or the actuators disposed laterally next to the telescopic push arm. The drawback of this solution is that even the smallest types of energy chains require a relatively large minimum radius in order to maintain the useful life of the cable lines over a relatively long time. For this reason, the installation space is relatively large, and it is therefore not possible to satisfy the requirement increasingly to be met at the present time, which is to provide a load-receiving device that is as compact and small as possible.

Another known design consists in that the energy supply of the sensors and/or the actuators is realized on the outer carriage in the form of a compact cable drum with sliding ring bodies. The drawback of this solution is the large size of the cable drum conditioned by the required minimum diameter of the cable, as well as the high weight and the relatively high costs. Designs of this type can be employed only with larger structures of telescopic push arms.

Another, highly space-saving design for a transmission means for supplying the sensors and/or the actuators on the outer carriage with electrical energy is known from US 2003/0185656 A1 as well, where the stranded flexible steel wires of the toothed belts for driving the intermediate center carriage and the outer carriage in and out, are employed at the same time as means for transmitting the electrical energy, permitting a highly space-saving energy supply at favorable cost in this way. However, this solution is disadvantageous in that for functional reasons, such an arrangement can be realized only for telescopic push arms with only one movable carriage, or maximally with only one movable carriage, or one intermediate carriage and one outer carriage at the most.

The problem of the present invention is to provide a telescopic push arm for storing or delivering loads, as well as a load-receiving device that permit safe transfer of energy between an interface arranged on a lifting platform of a conveying vehicle, and a sensor and/or actuator mounted on an extendable carriage, such push arm and such device being characterized by a simple and compact as well as low-maintenance design.

The problem of the invention is resolved by the features specified in the characterizing clauses of claims 1, 12 and 41. The advantages offered in this connection include that the electrical energy for a sensor and/or an actuator arranged on the extendible carriage, and/or a signal for the actuator can be supplied by means of a sliding cable line arrangement provided between the support frame and the carriage, and that the energy and/or a signal can be tapped from the sliding line line arrangement by means of one or two sliding-body arrangements provided between the support frame and the carriage. In other words, the one or more sliding-body arrangements are connected with the sliding-line arrangements via sliding contacts, which ensures a continuous energy supply for the sensor and/or the actuator, e.g. a servo-drive on the outer carriage, in any position of the carriage in relation to the support frame. The sliding-line and sliding-body arrangements are structured in a very compact way, so that the telescopic push arm and the load-receiving device can be realized with small dimensions. Therefore, it is now possible also to increase the number of auxiliary loading means accommodated in the shelf storage system because owing to the small structure of the telescopic push arm, it is possible to reduce the spacing between two auxiliary loading means deposited next to one another in the shelf storage system.

The embodiments according to claims 2 to 5 and 13 to 16 are advantageous in that due to the alternating arrangements of the sliding-line and sliding-body arrangements on the support frame or carriage, a flexible adaptation to the operational requirements is possible without having to change the compact installation measurements. If the telescopic push arm can be extended in both directions with respect to the lifting platform, the support frame or carriage is equipped with two sliding-body arrangements, which are mounted as closely as possible to the face-side end areas of the support frame or carriage, so that in such a compact embodiment, the length of extension from the carriage itself is not restricted. Furthermore, the modular structure of the transmission means comprising the sliding-line and sliding-body arrangements is beneficial as well in that only as many sliding-line and sliding-body arrangements have to be employed as exactly required by the number of carriages of the telescopic push arm, or as required by the extension of the latter in only one or in two directions, which means that the telescopic push arm can be manufactured in a particularly economical way.

The embodiments according to claims 6 to 8 and 17 to 19 are advantageous in that the multiple-extensible telescopic push arm now can be extended to such an extent that auxiliary loading means can be stored in and removed from the shelf storage system both in a front storage space located close to the aisle in the direction of extension of the telescopic push arm, and in a rear storage space located far from the aisle. The degree of utilization of the shelf storeroom and its efficiency and consequently the economy of the storage system can be increased in this way. In this connection, the shelves are set up either only on one side next to a conveying vehicle, or on both sides of the latter, whereby the telescopic push arm can be extended then only in one or in both directions with respect to the lifting platform. A reliable supply of the sensor and/or the actuator provided on the outer carriage with electrical energy, and/or the transmission of signals to the sensor and/or the actuator, is accomplished by transmitting energy and/or signals first from the sliding cable line and sliding body arrangements installed between the support frame and the intermediate carriage, to the sliding-line and sliding-body arrangements installed between the intermediate carriage and the outer carriage, and subsequently then to a sensor and/or an actuator.

The further developments according to claims 9 to 11 and 20 to 22 are advantageous as well in that the multiple-extendible telescopic push arm is structured in this way in a robust way, and capable of reaching long extension distances, so that in the direction of extension, said telescopic arm is capable of servicing also a number of storage compartments in the storage shelf system, which are disposed one after the other, for stowing away auxiliary loading means or removing the latter from storage.

The measure according to claim 23 permits reliable energy supply and/or signal transmission even with the telescopic push arm disposed in its maximally extended position.

According to claim 24, the length of the sliding contact of the sliding-body arrangement is coordinated in such a way that the minimum contact surface area for safely supplying energy and/or safely transmitting signal is realized, and maximally possible surface contact pressure for reducing wear, and smooth sliding of the sliding body arrangement are achieved as well, but not exceeded.

A realizable advantageous embodiment of the sliding-line and sliding-body arrangement is specified in claim 25.

However, the problem of the invention can be resolved also by the features specified in the characterizing clause of claim 26, which are advantageous in that electrical energy and/or signals can be transmitted free of contact wirelessly between an interface arranged on the lifting platform, and an actuator and/or sensor arranged on the outer carriage, so that mechanical wear is avoided, and maintenance work on the telescopic push arm in minimized. In addition, the transmitting and/or receiving units arranged opposite each other on the support frame and on the carriage, are distanced from one another with a small spacing by an air gap, so that the requirements to be met with respect to the tolerances of the linear guides arranged between the support frame and the carriage are low, while the advantage of safe energy supply and/or signal transmission between the transmitting and/or the receiving units is nonetheless preserved. Furthermore, it is beneficial that the telescopic push arm can be used without any restrictions under harsh ambient operating conditions such as dust and the like.

The embodiments according to claims 27 to 32 are advantageous in that owing to the alternating arrangement of the transmitting and/or receiving units on the support frame or carriage, flexible adaptation to the operationally conditioned requirements is possible without having to change the compact installation measurements. If the telescopic push arm is extendible with respect to the lifting platform in both directions, the support frame or the carriage is equipped with at least two transmitting and/or receiving units, which are mounted as closely as possible to the face-side end areas of the support frame or carriage, so that the distance of extension from the carriage itself is not restricted even with such a compact design of the telescopic push arm. The modular structure of the transmitting means comprising the transmitting and/or receiving units is beneficial as well.

The embodiments according to claims 33 and 34 are advantageous as well, because the multiple-extendible telescopic push arm can now be extended to such an extent that the auxiliary loading means can be stored in and removed from the shelves both in storage places disposed close to the aisle in the direction of extension of the arm, and in rearward storage place disposed located far from the aisle. The storage shelves are set up only on one side next to a conveying vehicle, or on both sides of the latter, whereby the telescopic push arm can then be extended from the lifting platform only in one or in both directions. Reliable supply of the sensor and/or actuator provided on the outer carriage with electrical energy, and /or reliable transmission of signals to the sensor and/or actuator are ensured by transmitting energy and/or signals from the transmitting and/or receiving units arranged between the support frame and the intermediate carriage, to the transmitting and/or receiving units arranged between the intermediate carriage and the outer carriage, and then further to a sensor and/or an actuator.

The further developments according to claims 35 and 36 are advantageous as well in that the multiple-extendible telescopic push arm is provided with a robust structure in this way, and capable of extending over large distances, so that in the direction of extension of the telescopic push arm, the latter is capable of reaching also a number of storage places disposed in the shelf storage system one after the other, where auxiliary loading means can be then stored or removed from storage as well.

Finally, advantageous embodiments for the transmitting and/or receiving units are specified in claims 37 to 40.

The invention is described in greater detail in the following with the help of the exemplified embodiments shown in the drawings, in which:

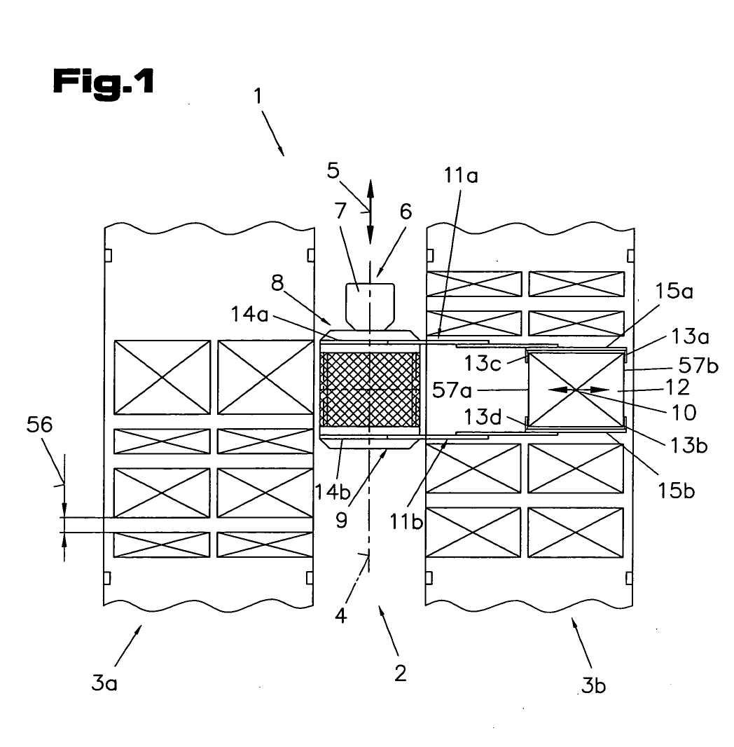

FIG. 1 is a top view and schematic representation of a cutout from a storage system with two shelf storage sections and a conveying vehicle, particularly a shelf-servicing device displaceably arranged between said storage sections, with a lifting platform and a load-receiving device as defined by the invention, the latter being mounted on said lifting platform.

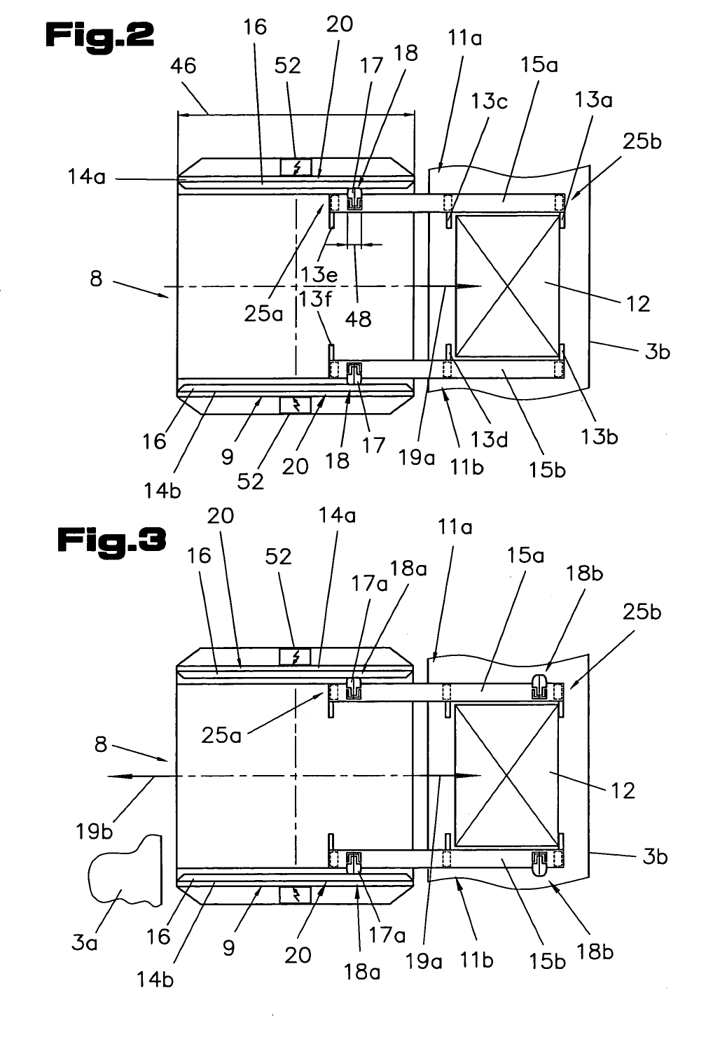

FIG. 2 is a top view and schematic representation of the load-receiving means as defined by the invention mounted on the lifting platform, for storing an auxiliary loading means in or removing it from a single shelf, with a first embodiment of telescopic push arms as defined by the invention extendible in one direction.

FIG. 3 is a top view and schematic representation of the load-receiving device as defined by the invention mounted on the lifting platform for storing an auxiliary loading means in or removing it from a single shelf, with a first embodiment of a telescopic push arm as defined by the invention extendible in both directions.

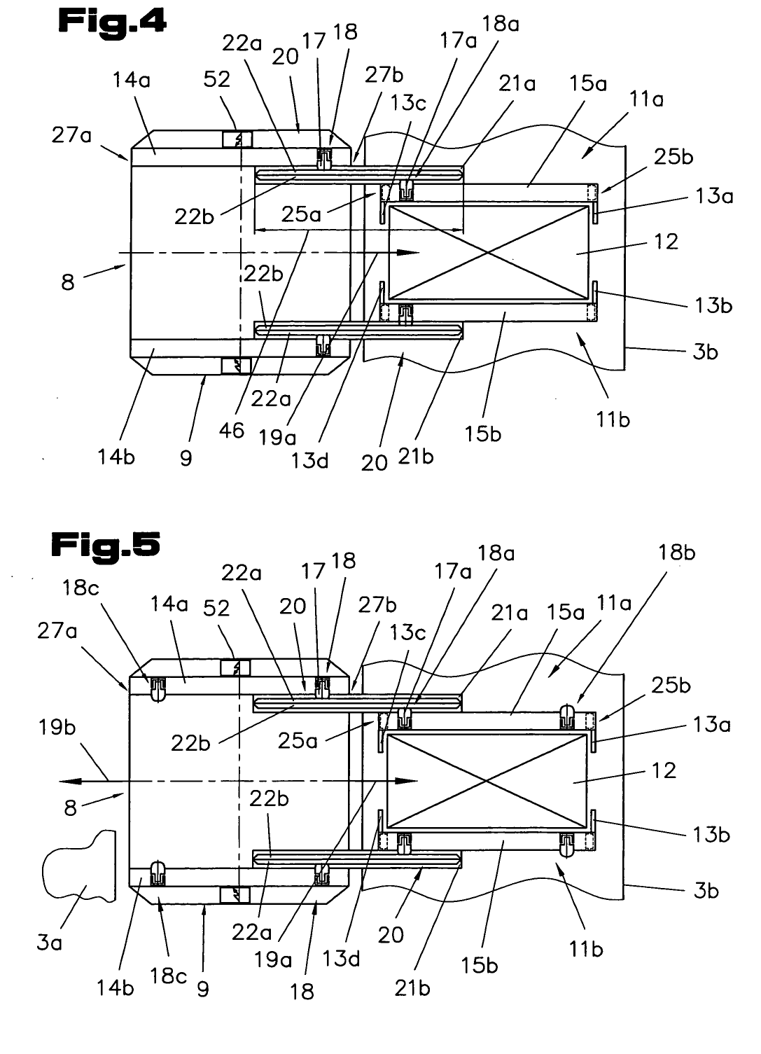

FIG. 4 is a top view and schematic representation of the load- receiving device as defined by the invention mounted on the lifting platform for storing an auxiliary loading means in or removing it from a single shelf, with a second embodiment of a telescopic push arm extendible in one direction.

FIG. 5 is a top view and schematic representation of the load-receiving device as defined by the invention mounted on the lifting platform for storing an auxiliary loading means in or removing it from a single shelf, with a second embodiment of telescopic push arms as defined by the invention extendible in both directions.

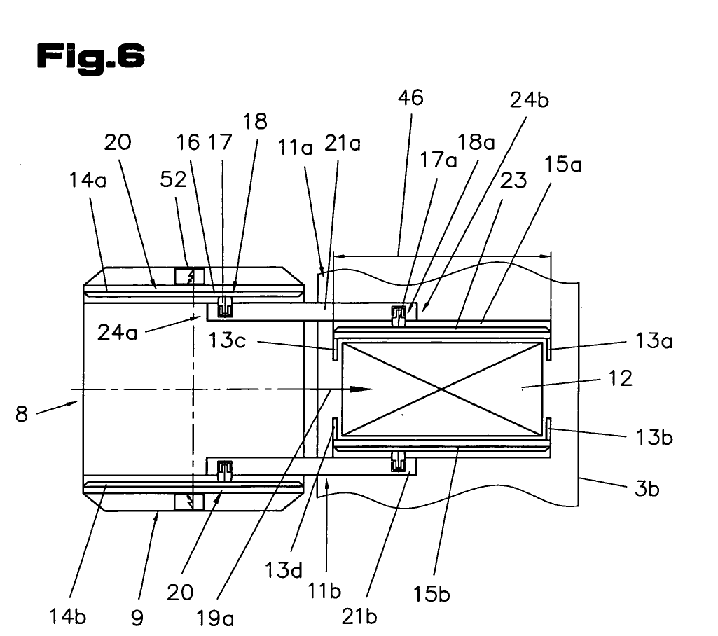

FIG. 6 is a top view and schematic representation of a load-receiving means mounted on the lifting platform for storing an auxiliary loading means in pr removing it from a single shelf, with a third embodiment of telescopic push arms as defined by the invention extendible in one direction.

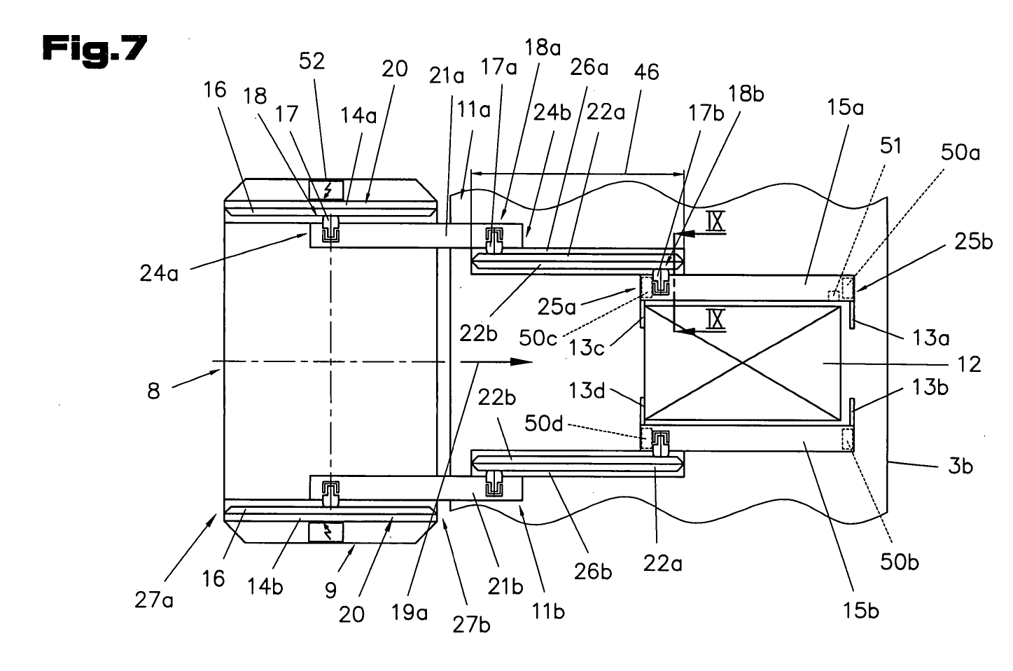

FIG. 7 is a top view and schematic representation of the load-receiving means as defined by the invention mounted on the lifting platform for storing an auxiliary loading means in or removing it from a double shelf, with a fourth embodiment of telescopic push arms extendible in both directions.

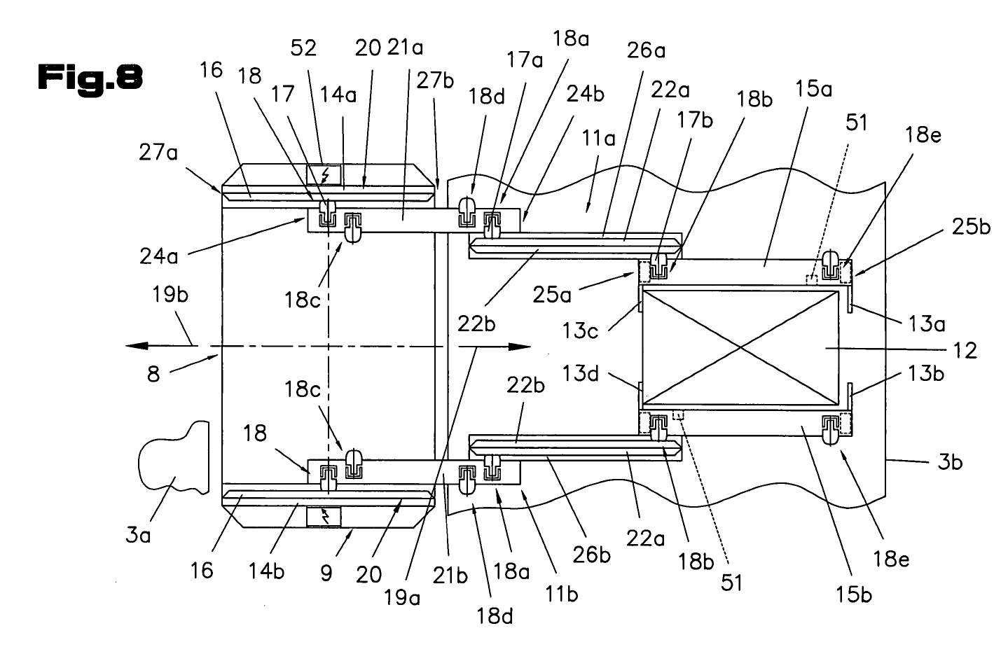

FIG. 8 is a top view and schematic representation of the load-receiving means as defined by the invention mounted on the lifting platform for storing an auxiliary loading means in or removing it from a double shelf, with a third embodiment of telescopic push arms extendible in both directions.

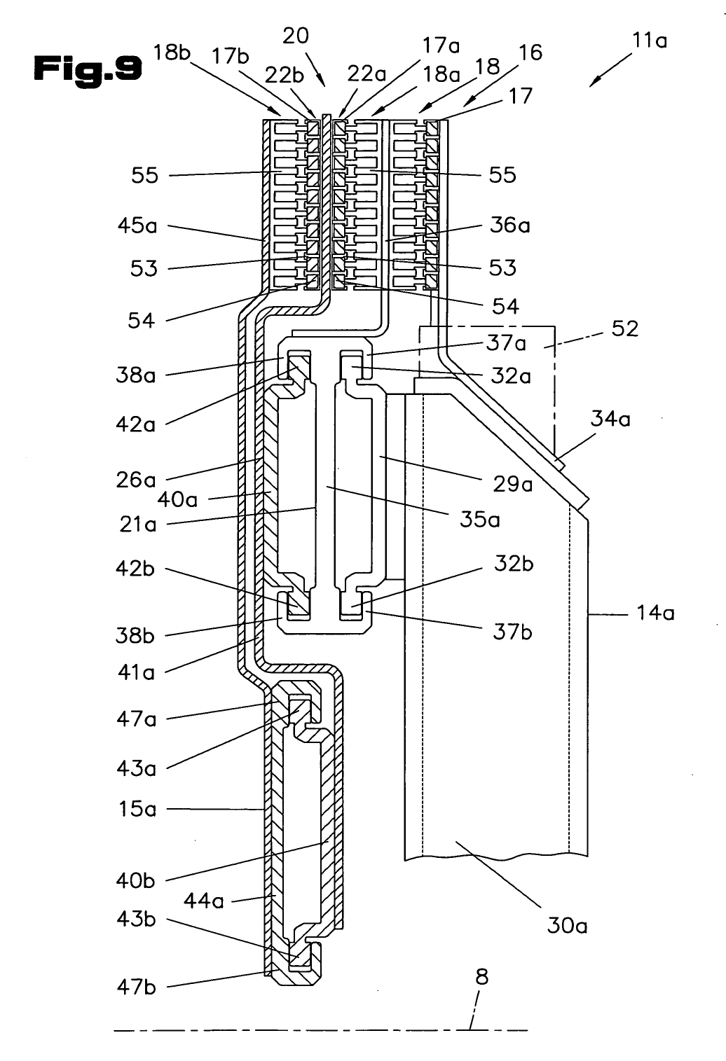

FIG. 9 is a sectional front view cut according to line IX-IX in FIG. 7, and simplified representation of one of the telescopic push arms of the load-receiving means, with a support frame, a first and a second intermediate carriage, an outer carriage, and a transmission means comprising sliding-line and sliding-body arrangements for transmitting energy and/or signals.

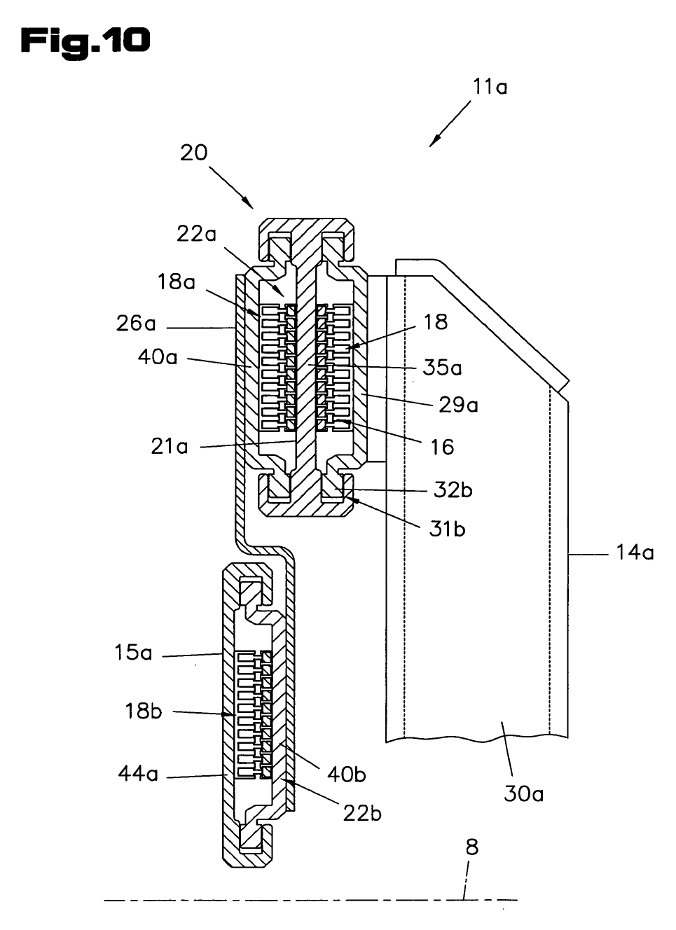

FIG. 10 is a partly sectional face view and simplified representation of one of the telescopic push arms of the load-receiving device, with a support frame, a first and a second intermediate carriage, an outer carriage, and a transmission means for transmitting current and/or signals comprising another design of sliding-line and sliding-body arrangements.

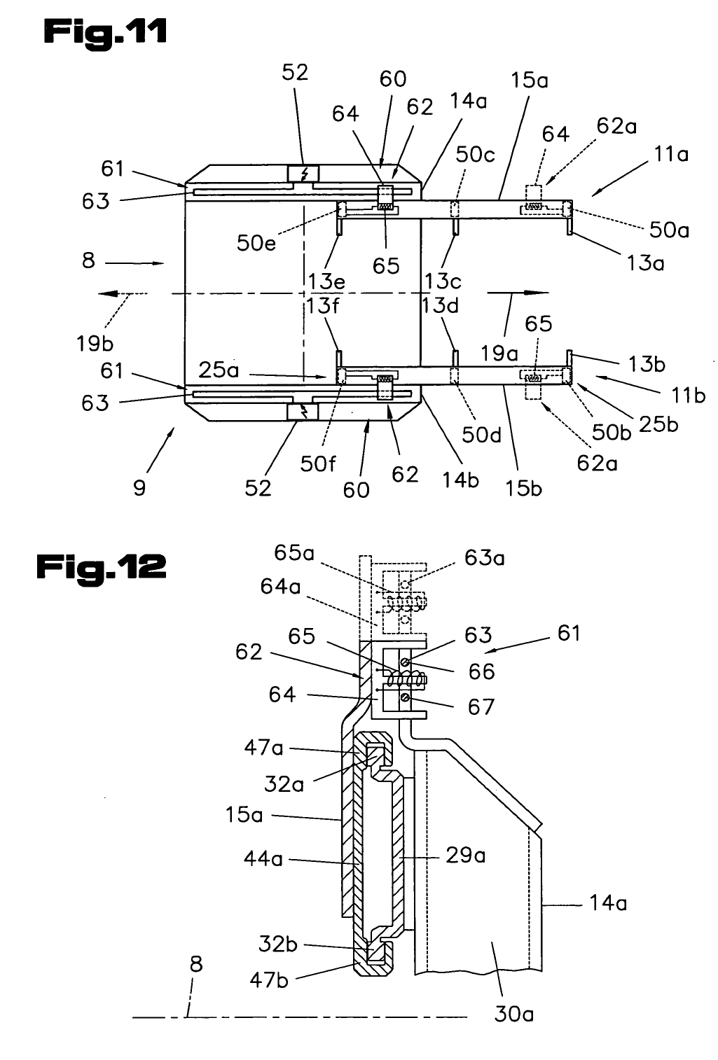

FIG. 11 is a top view and schematic representation of the load- receiving device as defined by the invention mounted on the lifting platform for storing an auxiliary loading means in and removing it from a single shelf, with another design of the transmission means for transmitting electrical energy and/or signals.

FIG. 12 is a sectional front view and schematic representation of a section of the telescopic push arm according to FIG. 11, with a transmission means for transmitting electrical energy and/or signals.

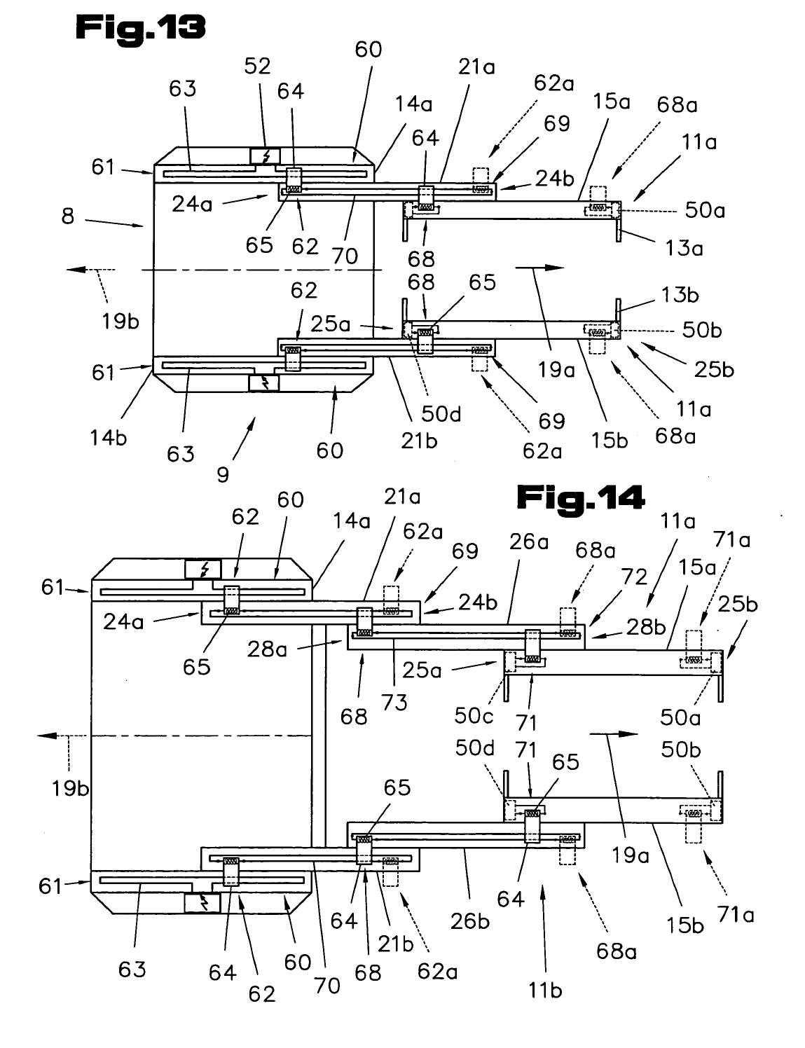

FIG. 13 is a top view and schematic representation of the load-receiving means as defined by the invention mounted on the lifting platform for storing an auxiliary loading means in and removing it from a double shelf, with another design of the telescopic push arms with transmission means for transmitting electrical energy and/or signals; and

FIG. 14 is a top view and schematic representation of the load-receiving means as defined by the invention mounted on the lifting platform for storing an auxiliary loading means in and removing it from a double shelf, comprising yet another design of the telescopic push arms with the transmission means for transmitting electrical energy and/or signals.

It is noted by way of introduction that identical components of the various embodiments described herein are provided with the same reference numbers or same component designations, whereby the disclosures contained throughout the specification can be applied in the same sense to identical components with the same reference numbers or the same component designations. Furthermore, data specifying positions such as, i.e. “top”, “bottom”, “lateral” etc., relate to the directly described and shown figure, and have to be applied to any new position where a position has changed. Moreover, individual features or combinations of features of the different exemplified embodiments shown and described herein may per se represent inventive solutions or solutions as defined by the invention.

FIG. 1 shows a cutout of a storage system 1 shown by a simplified representation. Said storage system comprises the shelf storage sections 3a, 3b on both sides of an aisle 2, and a conveying vehicle not shown in detail, particularly a shelf-servicing device 6 that is displaceable in both directions along the aisle 2 as indicated by the double arrow 5 and preferably guided on a rail 4. The shelf-servicing device 6 has a vertical mast 7, on which the raisable and lowerable lifting platform 8 is guided. A load-receiving device 9 for storing an auxiliary loading means 12 in or removing the latter from a shelf storage system section 3a, 3b, is arranged on the lifting platform 9. As indicated by the double arrow 10, said lifting platform 9 comprises the two telescopic push arms 11a and 11b, which extend parallel to one another and are spaced from each other. Said telescopic push arms are synchronously adjustable in the same sense in the driving-in and driving-out directions transversely to the aisle 2. According to the embodiment shown here, and as shown in greater detail in FIGS. 7 and 8, the telescopic push arms 11a and 11b each have a support frame 14a and 14b, a first and a second intermediate carriage, as well as an outer carriage 15a and 15b, respectively, the latter being disposed adjacent to the auxiliary loading means 12 to be transported. The intermediate carriages are adjustable in relation to the support frames 14a, 14b, and the carriages 15a, 15b are adjustable relative to one another.

As shown in FIG. 1, the outer carriages 15a and 15b are each provided with the driving elements 13a, 13b, 3c, 3d, which are arranged spaced from each other in the directions of retraction and extension, and adjustable, particularly pivotable transversely to the longitudinal direction of the telescopic push arms 11a, 11b, and are, for example separately controllable, whereby their spacing is greater than the dimension of the auxiliary loading means 12 measured between its front and rear side walls, viewed in the direction in which the telescopic push arm 11a, 11b is extended.

When an auxiliary loading means 12 is stored in the shelf system section 3a, 3b, the rear (viewed in the direction of extension) pair of the driving elements 3c, 13d is adjusted from an idle position to an operating position projecting beyond the outer periphery of the telescopic push arms 11a and 11b. With the driving elements 13c and 13d in their operating positions, the front (viewed in the direction of extension) side wall 57a of the auxiliary loading means 12 that has to be stored in the storage compartment in the shelf system section 3a, 3b close to or far from the aisle, is positively engaged from behind. The auxiliary loading means 12 is subsequently pushed from the lifting platform 8 into the shelf system section 3a, 3b solely owing to the extending movement of the telescopic push arm 11a, 11b.

When the auxiliary loading means 12 is removed from the shelf system 3a, 3b and loaded on the lifting platform 8, the telescopic push arms 11a, 11b are displaced on both sides next to the auxiliary loading means 12 to be removed, and driven beyond the rear side wall 57b of said auxiliary loading means, whereupon the front (viewed in the direction of extension) pair of the driving elements 13a, 13b is adjusted from its idle to its operating position protruding beyond the outer periphery of the telescopic push arms 11a, 11b. With the driving elements 13a, 13 in their operating positions, the rear (viewed in the direction of extension) side wall 57b of the auxiliary loading means 12 stored in a storage compartment in the shelf storage system section 3a, 3b close to or far from the aisle, is positively engaged from behind. Thereafter, the auxiliary loading means 12 is pushed from the storage shelf section 3a, 3b and onto the lifting platform 8 solely owing to the retracting movement of the telescopic push arms 11a and 11b.

The driving elements 13a, 13b, 3c, 13d of each telescopic push arm 11a, 11b, said driving elements being adjustable from their idle to their operating positions, are coupled to at least one electrical servo-drive (actuator) not shown, particularly an electrical motor. The idle and operations positions of the driving elements 13a, 13b, 3c, 13d are each monitored via a sensor not shown. The servo-drives and the sensors of the telescopic push arms 11a and 11b are arranged on the outer carriage 15a and 15b, respectively. It is, of course, possible to arrange on the outer carriages 15a and 15b also additional, separately controllable actuators and/or sensors serving other functions.

For feeding the actuator and/and or sensors with electrical energy and/or signals, each telescopic push arm 11a, 11b comprises a transmission means 20, which is described in the following figures.

FIG. 2 shows a highly simplified representation of a lifting platform 8 on which the load-receiving device 9 is mounted. Said load-receiving device is comprised of the two telescopic push arms 11a and 11b, which are arranged parallel next to and spaced from one another. The unilaterally extendible telescopic push arms 11a and 11b each have a support frame 14a and 14b, respectively, and a carriage 15a and, respectively, 15b, which is displaceably supported on said support frame on a linear guide in the longitudinal direction. The support frames 14a and 14b are secured on the lifting platform 8. A driving force is transmitted to said carriages 15a and 15b for synchronously retracting or extending the said carriages. As already described above, three driving elements 13a, 13b, 13c, 13d, 13e, 13f, as well as sensors (not shown) and servo-drives (actuators) shown by broken lines are arranged on each carriage 15a and 15b. Each driving element 13a to 13f is adapted for pivoting by means of a servo-drive from its idle into its working position about an axis extending in the longitudinal direction of the telescopic push arm 11a, 11b. In their operating positions, the driving elements 13a to 13f positively engage the auxiliary loading means 12, seizing it around its head or tail side wall.

Each telescopic push arm 11a and 11b comprises a transmission means 20 for feeding electrical energy and/or transmitting signals from an energy and/or signal interface 52 arranged on the lifting platform 8, to the actuators and/or sensors on the carriages 15a and 15b, respectively. According to the present embodiment, the transmission means 20, which is electrically conductively connected to the interface 52, is formed by a sliding-line arrangement 16 and a sliding-body arrangement 18, whereby at least one electrical sliding contact 17 is formed between the sliding-line arrangement 16 and the sliding-body arrangement 18. The sliding-line arrangement 16 is formed by several sliding lines and secured on the support frame 14a, 14b on its side facing the carriage 15a, 15b, respectively. The length 46 of the sliding-line arrangement 16 approximately corresponds with the length of the support frame 14a, 14b. The sliding-body arrangement 18 is formed by several sliding bodies, particularly spring-actuated sliding carbon brushes, and secured on the carriage 15a, 15b in the tail end area 25a opposing the telescopic push arm 11a, 11b in the direction of extension according to arrow 19a. The length 48 of the sliding contact 17 of the sliding body arrangement 18 between the sliding-line arrangement 16 and the sliding-body arrangement 18 corresponds to a fraction of the length 46 of the slip line arrangement 16. The sliding- line arrangement 16 of the telescopic push arms 11a, 11b is connected in each case to an interface 52, which in turn supplies the sliding-line arrangement 16 with electrical energy, or signals are transmitted from the interface 52 to the sliding-line arrangement 16. Said interface 52 is connected to an overriding control, e.g. a control with a programmable memory, and/or to an external energy source.

Another embodiment (not shown) of the unilaterally extendible telescopic push arms 11a, 11b consists of an arrangement of the sliding-line and sliding-body arrangements 16 and 18, respectively, such arrangement representing an alternative to FIG. 2. In said alternative arrangement, the sliding-line arrangement 16 is secured on the carriage 15a, 15b on its side facing the support frame 14a, 14b, respectively, and substantially extends over the entire length of the carriage 15a, 15b. However, the sliding-body arrangement 18, on the other hand, is secured on the support frame 14a, 14b in the front end area viewed in the direction of extension of the telescopic push arms 11a, 11b, as indicated by the arrow 19a. Each sliding-body arrangement 18 of the telescopic pushing arms 11a, 11b is connected to an interface 52, which in turn supplies the sliding-body arrangement 18 with electrical energy, or signals are transmitted from the interface 52 to the sliding-body arrangement 18.

The sliding-line and sliding-body arrangements 16 and 18, respectively, are electrically insulated vis-à-vis the support frames 14a and 14b and the carriages 15a and 15b, respectively.

The electrical energy for a sensor and/or an actuator on the carriage 15a, 15b, and the signals for the actuator are supplied by means of the sliding-line arrangement 16 provided between the support frame 14a, 14b and the carriage 15a, 15b, and tapped by means of the sliding-body arrangement 18 between the support frame 14a, 14b, and the carriage 15a, 15b, respectively.

Now, since the sliding bodies of the sliding-body arrangement 18 are guided or sliding along the sliding lines of the sliding-line arrangement 16, and are electrically connected to each other, and owing to the fact that at least one sliding body is permanently pressed against and in contact with at least one electrically conductive sliding-line (not shown), electrical energy and/or signals can be transmitted to the actuator and/or sensor as the telescopic push arms 11a and 11b are being extended or retracted.

The embodiment of the load-receiving device 9 according to FIG. 3 is different from the one according to FIG. 2 only on account of the fact that the telescopic push arms 11a and 11b are extendible with respect to the lifting platform 8 in both directions, and that their carriages 15a and 15b, respectively, are each provided in the two end areas 25a and 25b with a sliding-body arrangement 18a and 18b, respectively. The sliding-body arrangements 18a and 18b of the carriages 15a and 15b, respectively, are structurally separated from each other, and electrically conductively connected to one another, if necessary, which, however, is not shown. Each sliding-line arrangement 16 is again secured on the support frames 14a and 14b. Now, with such an embodiment, it is possible to service by means of the load-receiving device 9 two storage shelf sections 3a and 3b set up on both sides of the shelf-servicing equipment 6, i.e. the auxiliary loading means 12 can be stored in and removed from said storage shelves. When the carriages 15a and 15b are extended to the right in the direction of extension indicated by arrow 19a, the sliding-body arrangements 18a arranged in the rear (viewed in the direction of extension indicated by arrow 19a) end area 25a of the carriages 15a and 15b, are electrically connected with the sliding-line arrangements 16 via the sliding contacts 17a. However, on the other hand, when the carriages 15a and 15b are extended to the left in the direction of extension indicated by arrow 19b, the sliding-body arrangements 18b arranged in the rear (viewed in the direction of extension according to arrow 19b) end area 25b of the carriages 15a, 15b are electrically connected to the sliding-line arrangements 16 via the sliding contacts 17b (not shown). This means that irrespectively of the direction in which the carriages 15a, 15b of the telescopic push arms 11a, 11b are extended, an electrical connection is always maintained between the interface 52 and the sensors and/or actuators via the sliding-line and sliding-body arrangements 16 and 18a or 18b, respectively, and said sensors and/or actuators can be supplied with current, and/or signals can be transmitted.

Another embodiment (not shown) of the telescopic pushing arms 11a and 11b, which extendible in two directions with respect to the lifting platform 8, consists of an arrangement of the slip line and sliding body arrangements 16, 18a, 18b that represents an alternative to the design according to FIG. 3. In said alternative embodiment, the sliding-line arrangement 16 is secured on the carriage 15a, 15b on its side facing the support frame 14a, 14b, and substantially extending over the entire length of the carriage 15a, 15b, whereas the structurally separated sliding body arrangements 18, on the other hand, are secured on the support frame 14a, 14b in the face-side end areas of the latter opposing one another. The sliding-body arrangements 18a, 18b of the telescopic pushing arms 11a, 11b are connected to an interface 52, which in turn supplies the sliding-line arrangements 18a and 18b with electrical energy, or signals are transmitted from the interface 52 to the sliding-body arrangement 18a, 18b.

FIG. 4 shows by a highly simplified representation the lifting platform 8, on which the load-receiving device 9 as defined by the invention is mounted. The load-receiving device 9 has the two telescopic push arms 11a and 11b, which are arranged parallel to each other and uni-laterally extendible with respect to the lifting platform 8, and which each comprise a support frame 14a, 14b secured on the lifting platform 8, an outer carriage 15a, 15b that is adjustable in relation to said support frame 14a, 14b, as well as an intermediate carriage 21a, 21b arranged between the support frame 14a, 14b and the carriage 15a, 15b. The carriages 15a, 15b and the intermediate carriages 21a, 21b, respectively, are adjustable relative to one another and are guided in a linearly displaceable manner in linear guides, particularly in slide guides extending in the longitudinal direction of the telescopic pushing arm 11a, 11b. The outer carriage 15a, 15b is equipped with the driving elements 13a, 13b, 13c, 13d described above, which are adjustable by means of the actuators indicated by broken lines, whereby during the storing or removal process, a pair of the driving elements 13a, 13b; 13c, 13d positively engages the auxiliary loading means 12, seizing the latter around its rear or front side wall viewed in the direction of extension according to arrow 19a.

According to the present design of the transmission means 20 of each telescopic push arm 11a, 11b, each intermediate carriage 21a, 21b has a sliding-line arrangement 22a, 22b on its side facing the support frame 14a, 14b and the carriage 15a, 15b. The support frame 14a, 14b of the telescopic push arm 11a, 11b, is provided in its front—viewed in the direction of extension according to arrow 19a—end area 27b with a sliding-body arrangement 18, 18a, and the carriage 15a, 15b of the telescopic push arms 11a, 11b is provided with such a sliding-body arrangement 18, 18a in its opposite, trailing—viewed in the direction of extension according to arrow 29a—end area 25a, whereby at least one electrical sliding contact 17 and 17a is formed in each case between a sliding-line arrangement 22a, 22b and a sliding-body arrangement 18, 18a. The sliding-line arrangements 22a and 22b secured on the intermediate carriages 21a and 21b, respectively, are electrically conductively connected with each other, and have the length 46, which substantially extends over the entire length of the intermediate carriage 21a, 21b. Each sliding-line arrangement 22a, 22b may form a constructional unit produced as one single piece.

The sliding-body and sliding-line arrangements 18, 18a; 22a, 22b of the transmission means 20 are electrically insulated versus the support frame 14a, 14b, the outer carriage 15a, 15b, and the intermediate carriage 21a, 21b, and form the electrical connection between the interface 52 and a sensor and/or actuator arranged on the outer carriage 15a, 15b. The sliding-body arrangements 18 of the telescopic push arms 11a and 11b are connected to an interface 52.

Current and/or an electrical signal is transmitted from the interface 52 to the sensor and/or actuator arranged on the outer carriage 15a, 15b via the sliding-body and sliding-line arrangements 18, 18a; 22a, 22b, said arrangements being electrically connected by means of the sliding contact 17, 17a irrespectively of whether the telescopic push arms 11a and 11b have been retracted into their basic positions on the lifting platform 8, or extended into the shelf system section 3a into a transporting position.

The type of embodiment according to FIG. 5 is different from the one according to FIG. 4 only in that the telescopic push arms 11a and 11b are extendible in both directions with respect to the lifting platform 8, and that the outer carriages 15a and 15b, and also the support frames 14a and 14b are each provided in their oppositely disposed face-side end areas 25a, 25b; 27a, 27b with a sliding-body arrangements 18a, 18b; 18, 18c. On its side facing the support frame 14a, 14b and the carriage 15a, 15b, each intermediate carriage 21a, 21b again has a sliding-line arrangement 22a, 22b. The sliding-line arrangements 22a and 22b and the sliding-body arrangements 18 and 18a form in each case an electrical sliding contact 17 and 17a, respectively. The sliding-line arrangements 22a and 22b on the intermediate carriages 21a and 22b, respectively, are electrically conductively connected to each other. Owing to such an arrangement of the sliding-body and sliding- line arrangements 18, 18a, 18b, 18c; 22a, 22b, an electrical connection is always established between the interface 52 and a sensor and/or actuator on the carriage 15a, 15b irrespectively of the direction of extension of the telescopic push arms 11a, 11b according to arrows 19a or 19b, such electric connection being maintained via one of the sliding-body arrangements per support frame 14a, 14b, the sliding-line arrangements 22a, 22b, and one of the sliding-body arrangements 18a or 18b per carriage 15a, 15b, so that current and/or signals can be supplied to such sensor and/or actuator.

Another type of embodiment (not shown) of the bilaterally extendible telescopic push arms 11a and 11b consists of an arrangement of the slip- body and sliding-line arrangements 18 to 18c; 22a, 22b that represents an alternative to FIG. 5, where the carriages 15a, 15b and the support frames 14a and 14b, respectively, each are provided with a sliding-line arrangement on sides facing one another, whereas the corresponding intermediate carriage 21a, 21b, however, is provided with a sliding-body arrangement on is sides facing the support frame 14a, 14b, and the carriage 15a, 15b, respectively, such sliding-body arrangement being disposed in each case in the face-side end areas opposing each other, whereby an electrical sliding contact is formed between each sliding-line arrangement and sliding-body arrangement. For transmitting current and/or signals, at least the sliding-body arrangements diagonally opposing one another on the respective intermediate carriages 21a, 21b, are electrically conductively connected to each other.

The embodiment of the load-receiving device 9 according to FIG. 6 shows a variation of FIG. 4, where a sliding-line arrangement 16, 23 is secured on each of the sides of the carriages 15a, 15b, and support frames 14a, 14b of the telescopic push arms 11a, 11b facing each other. On its side facing the support frame 14a, 14b, the intermediate carriage 21a, 21b is provided with a sliding-body arrangement 18 in the opposite, rear—viewed in the direction of extension as indicated by arrow 19a—end area 24a, and provided in the front—viewed in the direction of extension as indicated by arrow 19a—end area 24b with a sliding-arrangement 18a, whereby at least one electrical sliding contact 17, 17a is formed between the sliding-line arrangement 16, 12, and the slip-body arrangement 18, 18a, which means that the sliding-line and the slip-body arrangements 16, 23 and 18, 18a, respectively, are electrically connected. The sliding-body arrangements 18, 18a on the intermediate carriage 21a, 21b are electrically conductively connected to one another. The length 46 of the sliding-line arrangements 16, 23 substantially corresponds with the length of the support frame 14a, 14b, and of the carriage 15a, 15b.

FIG. 7 shows a highly simplified representation of a lifting platform 8, on which the load-receiving device 9 as defined by the invention is mounted. Said load-receiving device 9 has the two telescopic push arms 11a and 11b, which are arranged parallel to one another and unilaterally extendible with respect to the lifting platform 8, and which each comprise a support frame 14a, 14b, an outer carriage 15a, 15b that is adjustable relative to said support frame 14a, 14b; a first intermediate carriage 21a, 21b disposed adjacent to said support frame 14a, 14b; as well as a second intermediate carriage 26a, 26b that is disposed adjacent to the carriage 15a, 15b. In addition, each telescopic push arm 11a, 11b is equipped with a transmission means 20 for feeding electrical energy and/or transmitting signals from the energy and/or signal interface 52 to the servo-drives (actuators 50a to 50d) secured on the carriage 15a, 15b for the driving elements 13a to 3d, and/or to a sensor 51, said transmission means being formed by the sliding-line and slip-body arrangements 16, 22a, 22b; 18, 18a, 18b. The sensor 51 serves, for example for detecting the occupancy or availability status in the shelf storage section 3b or the like. The intermediate carriages 21a, 21b; 26a, 26b are adjustable in relation to the support frame 14a, 14b and the carriage 15a, 15b, and the intermediate carriages 21a, 21b; 26a, 26b are adjustable relative to one another. The first and second intermediate carriages 21a, 21b; 26a, 26b, and also the outer carriage 15a, 15b of each telescopic push arm 11a, 11b are displaceably guided in linear guides extending in the longitudinal direction of the telescopic push arms 11a and 11b.

On its side facing the carriage 15a, 15b, the support frame 14a, 14b is provided with the sliding-line arrangement 16, and the second intermediate carriage 26a, 26b neighboring on the carriage 15a, 15b, is provided with a sliding-line arrangement 22a, 22b on each of its sides facing the support frame 14a, 14b and the carriage 15a, 15b. On its side facing the support frame 14a, 14b, the first intermediate carriage 26a, 26b neighboring on the support frame 14a, 14b is provided in the rear-viewed in the direction of extension according to arrow 19a—end area 24a with the sliding-body arrangement 18, and in its side facing the carriage 15a, 15b in the front-viewed in the direction of extension according to arrow 19a—end area 24b with a sliding-body arrangement 18a. In the opposite rear-viewed in the direction of extension indicated by arrow 19a—end area 25a, the outer carriage 15a, 15b has a sliding-body arrangement 18b. The sliding-body arrangements 18 and 18a on the first intermediate carriage 21a and 21b, respectively, and also the sliding-line arrangements 22a and 22b on the second intermediate carriages 26a and 26b, respectively, are electrically conductively connected among each other in each case. The electrical sliding contacts 17, 17a and 17b are formed between the sliding-line arrangements 16, 22a, 22b, and the respective sliding-body arrangements 18, 18a, 18b, respectively, i.e., the sliding-body and sliding-line arrangements 18, 18a, 18b; 16, 22a, 22b are electrically connected by means of the sliding contacts 17, 17a and 17b, respectively.

Another embodiment (not shown) of the unilaterally extendible telescopic push arms 11a and 11b consists of an arrangement of the sliding-body and sliding-line arrangements 18, 18a, 18b; 22a, 22b representing an alternative to the one shown in FIG. 7. In said alternative embodiment, the carriage 15a, 15b has a sliding-line arrangement on its side facing the support frame 14a, 14b, and the first intermediate carriage 21a, 21b neighboring on the support frame 14a, 14b has a sliding-line arrangement on each of its sides facing the support frames 14a, 14b, and the carriages 15a, 15b, respectively. However he support frame 14a, 14b, on the other hand, is provided in its front - viewed in the direction of extension according to arrow 19a—end area 27b with a sliding-body arrangement, and the second intermediate carriage 26a, 26b neighboring on the carriage 15a, 5b, is provided with a sliding-body arrangement on its side facing the support frame 14a, 14b in the rear-viewed in the direction of extension indicated by arrow 19a—end area, as well as also in its front-viewed in the direction of extension indicated by arrow 19a—end area on its side facing the carriage 15a, 15b, with an electrical sliding contact being formed between each sliding-line arrangement and the sliding-body arrangement associated therewith. The sliding-line arrangements on the first intermediate carriage 21a, 21b, and also the sliding-body arrangements provided on the second intermediate carriage 26a, 26 are electrically conductively connected among each other in each case.

The embodiment according to FIG. 8 is distinguished from the one shown in FIG. 7 only on account of the fact that the telescopic push arms 11a and 11b can be extended with respect to the lifting platform 8 in both directions; that the first intermediate carriage 21a, 21b disposed neighboring on the support frame 14a, 14b is provided on each of its sides facing the support frames 14a, 14b and the carriage 15a, 15b with a sliding-body arrangement 18, 18a, 18c, 18d arranged in the oppositely disposed face-side end areas 24a, 24b; and that the carriage 15a, 15b is provided with a sliding-body arrangement 18b, 18e in each of the face-side end areas 25a, 25b opposing each other.

It is shown in FIG. 8 that an electrical sliding contact 17, 17a, 17b is formed between each sliding-line arrangement 16, 22a, 22b and sliding-body arrangement 18, 18a, 18b when the telescopic push arms 11a, 11b are extended to the right as indicated by arrow 19a, and driven into the shelf storage section 3b. When the telescopic push arms 11a, 11b are extended to the left (not shown in any detail) as indicated by arrow 19b, and driven into the shelf storage section 3a, an electrical slip-contact 17c, 17d, 17e is formed between each sliding-line arrangement 16, 22a, 22b and each sliding-body arrangement 18c, 18d, 18e, respectively.

Another embodiment (not shown) of the bilaterally extendible telescopic push arms 11a and 11b representing an alternative to the design shown in FIG. 8 consists of another arrangement of the sliding-line and sliding-body arrangements 16, 22a, 22b; 18 to 18e. In such an alternative arrangement, the carriage 15a, 15b is provided on its side facing the support frame 14a, 14b with a sliding-line arrangement, and the first intermediate carriage 21a, 21b disposed neighboring on the support frame 14a, 14b is provided with a sliding-line arrangement on each of its sides facing the support frame 14a, 14b and the carriage 15a, 15b, whereas the support frame 14a, 14b, however, is provided with a sliding-body arrangement in each of the oppositely disposed face-side end areas 27a, 27b, and the second intermediate carriage 26a, 26b neighboring on the carriage 15a, 15b is provided in oppositely disposed, face-side end areas with a sliding-body arrangement on each of its sides facing the support frame 14a, 14b and the carriage 15a, 15b, whereby an electrical sliding contact is formed between each sliding-line arrangement and each sliding-body arrangement. The sliding-line arrangements on the first intermediate carriage 21a, 21b, and also the sliding-body arrangements on the second intermediate carriage 26a, 26b are electrically conductively connected among each other in each case.

FIG. 9 shows a sectional front view of a preferred embodiment of a telescopic push arm 11a, 11b of the load-receiving device 9, said push arm being mounted on the only schematically indicated lifting platform 8. As already described above, the telescopic push arm 11a comprises the support frame 14, the first and the second intermediate carriages 21a and 26a, respectively, and the outer carriage 15a. The support frame 14a comprises an about C-shaped guide component 29a, a frame component 30a, and a mounting 34a secured on said frame component. The frame component 30a is in turn fastened on the lifting platform 8. The guide component 29a has a linear guide, so that the first intermediate carriage 21a, which is displaceable on the linear guide in the longitudinal direction, is guided on the support frame 14a. As shown in the present figure, the linear guide extending parallel to the directions of retraction and extension of the telescopic push arm 11a, comprises the two vertical and/or lateral guide tracks 32a, 32b, which are realized, e.g. as slide guides. The sliding-line arrangement 16 is arranged on the section-like mounting 34a of the support frame 14a on the side facing the first intermediate carriage 21a, said sliding-line arrangement 16 extending parallel to the directions of retraction and extension of the telescopic push arm 11a.

The first intermediate carriage 21a, which is displaceably guided on the support frame 14a and has an approximately I-shaped cross section, comprises a guide component 35a and an about L-shaped mounting 36a secured on the latter. Said guide component 35a has two linear guides that are separated from each other: one for guiding the first intermediate carriage 21a on the support frame 14a, and the other for guiding the second intermediate carriage 26a on the first intermediate carriage 21a. Thus the second intermediate carriage 26a is displaceably guided in the longitudinal direction on the first intermediate carriage 21a on one of the linear guides. As shown in the present figure, furthermore, the linear guides extending parallel to the direction of retraction and extension of the telescopic push arm 11a each comprise two vertical and/or lateral guide tracks 37a, 37b; 38a, 38b, which are separated from each other and designed, e.g. in the form of slide guides. The sliding-body arrangement 18 is secured on the section-like mounting 36a, particularly on the leg projecting upwards from the first intermediate carriage 21a on the side facing the mounting 34a of the support frame 14a, and the sliding-body arrangement 18a is fastened on the side facing away from the mounting 34a of the support frame 14a. The sliding-body arrangements 18, 18a extend parallel to the direction of retraction and extension of the telescopic push arm 11a.

The second intermediate carriage 26a comprises two approximately C-shaped guide components 40a and 40b, which are arranged one on top of the other, facing away from each other, and an about L-shaped mounting 41a secured on the top guide component 40a. The guide components 40a and 40b each have two linear guides separated from one another: one for guiding the second intermediate carriage 26a on the first intermediate carriage 21a, and the other for guiding the outer carriage 15a on the second intermediate carriage 26a. Thus the outer carriage 15a is displaceably guided in the longitudinal direction on the second intermediate carriage 26a in one of the linear guides. As shown in the present figure, the linear guides extending parallel to the direction of retraction and extension of the telescopic push arm 11a comprise two vertical and/or lateral guide tracks 42a, 42b; 43a, 43b, which are separated from one another and realized, for example as slide guides. The sliding-line arrangement 22a is secured on the section-like mounting 41a, particularly on the upwardly projecting leg of the second intermediate carriage 26a on the side facing the mounting 34a of the support frame 14a, and the sliding-line arrangement 22b is fastened on the side facing away from the mounting 34a of the support frame 14a. The sliding-line arrangements 22a, 22b extend parallel to the direction of retraction and extension of the telescopic push arm 11a.

The outer carriage 15a comprises a guide component 44a and a substantially plane, section-like mounting 45a secured thereon. The guide component 44a has a linear guide for guiding the carriage 15a on the second intermediate carriage 26a. Thus the carriage 15a is displaceably guided on the second intermediate carriage 26a in the longitudinal direction by means of the linear guide. As shown in the present figure, the linear guide extending parallel to the direction of retraction and extension of the telescopic arm 11 a comprises two vertical and/or lateral guide tracks 47a, 47a, which are separated from each other and realized, e.g. as slide tracks. The sliding-body arrangement 18b is secured on the mounting 45a of the first intermediate carriage 21a on the side facing the mounting 34a of the support frame 14a, said sliding-body arrangement 18b extending parallel to the direction of retraction and extension of the telescopic push arm 11a.

The sliding-line arrangements 16, 22a, 22b, and the sliding-body arrangements 18, 18a, 18b form the transmission means 20 described above, whereby according to the present embodiment, a multitude of electrical sliding contacts 17, 17a, 17b, e.g. ten sliding contacts are formed between the respective sliding-line arrangements 16, 22a, 22b, and the sliding-body arrangement 18.

The sliding-line arrangements 16, 22a, 22b; 23 consist of a basic body made of insulation material, e.g. plastic, and at least one electrically conductive sliding line 54 in the form of a metal rail or the like. The sliding-body arrangements 18, 18a, 18b; 18c to 18e each consist of at least one electrically conductive sliding body 55 in the form of a spring-actuated sliding carbon brush or the like. Several sliding lines 54 disposed parallel to one another are usefully formed for motor currents, control currents and data transmission signals, along which several sliding bodies 55 slide over the entire distance of the path of retraction and extension of the telescopic push arm 11a, 11b. A sliding contact 17, 17a, 17b is realized by pressing the sliding body 55 against the sliding line 54. For example, provision is made for ten sliding lines 54 for each sliding-line arrangement 16, 22a, 22b; 23, and for ten slip-bodies 55 for each sliding-body arrangement 18, 18a, 18b; 18c to 18e.

It is not shown in any detail that the sliding-body arrangements 18 and 18a and the sliding-line arrangements 22a and 22b are electrically conductively connected to each other, whereby the sliding-line arrangement 16 supplies the sliding-body arrangement 18 with electrical energy and/or transmits signals to the latter; and the sliding-body arrangement 18a supplies the sliding-line arrangement 22a; the sliding-line arrangement 22a supplies the sliding-line arrangement 22b; and the sliding-line arrangement 22b the sliding-body arrangement 18b, and/or transmits signals to same. The sliding-body arrangement 18b is in turn connected to the actuators 50a to 50d and/or the sensor 51 shown in FIG. 7. The sliding line arrangement 16 is connected to the schematically shown interface 52, which is schematically indicated by the connection line.

It is shown already by FIG. 9 that the telescopic push arm 11a, 11b has a very compact structure, so that the spacing of the gap 56 required between two auxiliary loading means 12, which are stored next to each other in the shelf storage sections 3a, 3b can be narrow, as shown in FIG. 1.

It is additionally advantageous that the sliding-line and sliding-body arrangements 16, 22a, 22b; 23, 18 to 18b; 18c to 18d of the transmission means 20 are arranged on the side facing away from the lifting platform 8 above, and on the side facing the lifting platform 8 below the telescopic push arm 11a, 11b, particularly the intermediate carriage 21a, 21b and/or the intermediate carriage 6a, 26b, so that a very narrow width of the telescopic push arms 11a, 11b can be maintained, and the latter do not have to be widened because of the arrangement of the transmission means 20. This is made possible because the transmission means of the telescopic push arms 11a, 11b can be installed laterally next to the auxiliary loading means 12 in the free spaces that are available there in any case due to the structural height of said loading means to be transported, either above or below the respective telescopic push arm 11a, 11b.

Another arrangement of the sliding-line arrangements 16, 22a, 22b, and the sliding-body arrangements 18, 8a, 18b of the transmission means 20 is shown in FIG. 10. As shown there, the at least one sliding-body arrangement 18 is secured on the C-shaped guide component 29a of the support frame 14a on the side facing the first intermediate carriage 21a. The sliding-line arrangement 16 is secured on the guide component 35a of the first intermediate carriage 21a on the side facing the support frame 14a.

The sliding-line arrangement 22a is secured on the guide component 35a of the first intermediate carriage 21a on the side facing the second intermediate carriage 26a. The sliding-body arrangement 18a is secured on the C-shaped guide component 40a of the second intermediate carriage 26a on the side facing the support frame 14a. And the sliding-line arrangement 22b is secured on the further C-shaped guide component 40b of the second intermediate carriage 26a on the side facing the outer carriage 15a, 15b.

The sliding-body arrangement 18b is secured on the guide component 44a of the carriage 15a on the side facing the support frame 14a.

The sliding-line arrangements 16 and 22a are electrically connected to each other. Likewise, the sliding-body arrangement 18a and the sliding-line arrangement 22b are electrically connected with one another. The sliding-body arrangement 18 is connected to the interface 52 (not shown).

The embodiment according to FIG. 10 is advantageous in that the transmission means 20 remains protected to the greatest possible extent from external influences such as dirt, so that high operational safety of the telescopic push arm 11a, 11b is achieved.

It is noted again that the sliding bodies 55 are designed in the form of spring-actuated sliding carbon brushes or the like. Owing to retraction bevels on both sides of the sliding lines, and the beveled, elastically supported sliding bodies 55 of the sliding-body arrangements 18; 18a to 18c, the sliding-body arrangements 18; 18a to 18e can be safely and smoothly extended into and retracted from into the sliding-line arrangements 16, 22a, 22b; 23. The sliding-line arrangements 16, 22a, 22b; 23 are open to one side and in electrical contact with the sliding-body arrangements 18; 18a to 18e, particularly the sliding bodies 55. Each sliding-line arrangement consists of at least one electrically conductive sliding line 54, which is coordinated with the length of the associated intermediate carriage 21a, 21b; 26a, 26b; carriage 15a, 15b; or of the support frame 14a, 14b, and is electrically insulated.

In another embodiment, the sliding-body arrangements 18; 18a to 18e are doubled around their axes of symmetry, each comprising left and right sliding bodies 55, which ensures safe contacting between the sliding line 54 and the sliding body 55 and energy transmission even if one of the sliding bodies 55 is worn due to friction.

The sliding-line arrangement 16, 22a, 22b; 23 described above forms a current-feeding element, and the sliding-body arrangement 18; 18a to 18e a current collector.

The intermediate carriages 21a, 21b; 26a, 26b, and the outer carriages 15a, 15b of the telescopic push arms 11a, 11b are driven, for example by means of pulley drives not shown, particularly belt drives, whereby a driving force in applied to one of the intermediate carriages 21a, 2 1b, 26a, 26b, and transmitted by means of the belt drives to the other intermediate carriage 21a, 21b; 26a, 26b and the outer carriage 15a, 15b. An applicable driving concept for the embodiment according to FIG. 5 is known from US 2003/0185656 A1, and the detailed disclosure of said concept is hereby made an object of the present disclosure. In this connection, the support frame 14a, 14b and the outer carriage 15a, 15b are coupled to each other via two belts. The belts each are reversed by rollers supported in the front end areas viewed in the directions of extension of the telescopic push arm 11a, 11b according to arrows 19a and 19b, and secured with their first free ends on the support frame 14a, 14b, and with their second free ends fastened on the outer carriage 15a, 15b. The intermediate carriage 21a, 21b is driven.

The load-receiving device 9 as defined by the invention is shown in FIGS. 11 to 14 jointly described below. Said load-receiving means 9 again has the telescopic push arms 11a, 11b arranged parallel to and spaced from one another, and secured on the lifting platform 8 via the support frames 14a, 14b provided for said arms.

The telescopic push arms 11a and 11b according to FIG. 11 each have a support frame 14a and 14b, respectively, as well as a transmission means 60 arranged between said frames for feeding electrical energy and/or for transmitting signals from the energy and/or signal interface 52 arranged on the lifting platform 8, to the actuators 50a to 50f arranged on the outer carriage 15a, 15b, and/or the sensors (not shown in detail). The actuators 50a to 50f are formed by electric motors, with each electric motor being coupled to a driving element 13a to 13f adapted for pivoting about an axis extending in the longitudinal direction of the carriage 15a, 15b.

In the present embodiment, the transmission means 60 is formed by the transmitting and/or receiving units 61 and 62, between which an electromagnetic field is generated for transmitting energy and/or signals. The first transmitting and/or receiving unit 61 is arranged on the support frame 14a, 14b, and the second transmitting and/or receiving unit 62 on the outer carriage 15a, 15b. If the telescopic push arms 11a, 11b are designed for extending in only one direction, the second transmitting and/or receiving unit 62 is arranged in the rear end area 25a viewed against the direction of extension according to arrow 19a.

The first transmitting and/or receiving unit 61 is formed by a coil with a large surface area, particularly a conductor loop 63, which is substantially extending over the entire length of the support frame 14a, 14b and connected to the interface 52, which in turn supplies the conductor loop 63 with energy from an external energy source, and/or an external control unit with signals. The second transmitting and/or receiving unit 62 is formed by a fork-like, open ferromagnetic core 64, and a coil 65 mounted on said core. The windings of the coil 65 are preferably applied to the center prong of the core 64. The core 64 of the transmitting and/or receiving unit 62 is secured on the carriage 15a, 15 in such a way that the latter encloses a feed and return line 66, 67 of the conductor loop 63. The conductor loop 63 and the coil 65 are arranged neighboring on one another with a small spacing from each other, and disposed opposing each other, so that the transmission distance or air gap is as short as possible, which also minimizes possible losses.

When ac voltage is fed into the conductor loop 63 and ac current is flowing through said loop, current or voltage is induced in the coil 64 of the transmitting and/or receiving unit 62 as a result of the magnetic flow, with the amount and direction of such magnetic flow changing depending on the frequency of the ac voltage admitted into the conductor loop 63. The conductor loop 63 and the coil 65 are electrically insulated against one another, but magnetically coupled with each other. The coil 65 is therefore permeated by the magnetic field generated by the conductor loop 63 through which current is flowing.

If wireless transmission of electrical signals and electrical energy is to take place simultaneously, the support frame 14a, 14b is additionally provided in a first embodiment with a second conductor loop 63a having the first transmitting and/or receiving unit 61, as shown in FIG. 12 by broken lines, and the carriage 15a, 15b is additionally provided with a second coil 65a having the second transmitting and/or receiving unit 62. For this purpose, the coils 65, 65a of the second transmitting and/or receiving unit 62 each can be arranged on their own ferromagnetic coils 64, 64a, respectively, secured on the carriages 15a, 15b, as shown by broken lines in FIG. 12. Filtration required between energy and signals is omitted in such a case.

In a second embodiment not shown, the first transmitting and/or receiving unit 61 has the two conductor loops 63, 63a, and the second transmitting and/or receiving unit 61 has the two coils 65, 65a, whereby the latter are arranged on only one ferromagnetic core 64.

In a third embodiment for simultaneous transmitting signals and electrical energy, the first transmitting and/or receiving unit 61 has only one conductor loop 63, and the second transmitting and/or receiving 61 only one coil 65. An alternating magnetic field is formed in the transmission of ac current, which generates in the coil 65 an ac current with the same frequency. A high-frequency signal is superimposed on the alternating magnetic field. The signals are thus modulated upon the alternating magnetic field generated by the energy transmission. The voltage induced in the coil 65 is consequently present at a different voltage level and frequency. The signals modulated upon the electromagnetic field can be tapped off again from the latter, so that the signals and the energy can be tapped off again separately as well. Following filtration, the signals and the energy are present again in the form in which they were originally emitted by the conductor loop 63, and can be processed then in this form by a logic. The ac voltage induced by the conductor loops 63 and 63a in the coils 65 and 65a, respectively, can be, for example rectified and transformed into the required voltage. A current circuit is provided for this purpose, which is comprised of the coil 65 or 65a, a capacitor connected in parallel to the coil 65 or 65a mounted on the ferromagnetic core 64 or 64, respectively, and a diode. The diode and the capacitor represent a rectifier diode with a buffer capacity connected downstream in order to rectify again the ac voltage received for supplying energy.

The transmission of energy and/or signals between the transmitting and/or receiving units 61 and 62 may take place both by the full and semi-duplex methods.

If, ass opposed to the embodiment described above, the telescopic push arms 11a and 11b are extendible in both direction with respect to the lifting platform 8, the carriage 15a, 15b of said telescopic push arms 11a, 11b is additionally equipped with a transmitting and/or receiving unit 62 also in the further end area 25b, as shown by broken lines. If the telescopic push arms 11a and 11b are extended in the direction of extension according to arrow 19a to the right, ac voltage is induced only in the coil 65 or 65a, respectively, of the transmitting and/or receiving unit 62 arranged in the end area 25a. If, however, the telescopic push arms 11a and 11b are extended to the left according to the direction of extension according to arrow 19b as indicated by the broken line, ac voltage is induced only in the coil 65 or 65a of the second transmission and/or receiving unit 62a arranged in the end area 25b. The transmitting and/or receiving unit 62a has the same structure as the transmitting and/or receiving unit 62.

As shown in the figures, the coils 65 and 65a of the transmitting and/or receiving units 62 and 62a, respectively, are electrically conductively connected to the actuators 50a to 50f and the sensors (not shown) via connecting lines, and, where necessary, via the interconnected capacitor and rectifier diode.

FIG. 13 shows another embodiment of the telescopic pusher arms 11a and 11b for the load-receiving device 9. The telescopic push arms 11a and 11b each have a support frame 14a, 14b, an outer carriage 15a, 15b, and an intermediate carriage 21a, 21b, respectively, arranged between said frames and carriages, as already described in detail above. In addition, each telescopic push arm 11a, 11b is equipped with the transmission means 60 for feeding electrical energy and/or transmitting signals to the actuators 50a to 50d and/or sensors (not shown), said transmitting means comprising the transmitting and/or receiving units 61, 62, (62a), 68, 69. The support frame 14a, 14b of the telescopic push arms 11a, 11b is again provided with the first transmitting and/or receiving unit 61, which is formed by the conductor loop 63 connected to the interface 52.

If the telescopic push arms 11a and 11b are suitable only for unilateral extension, the intermediate carriage 21a, 21b is provided in the rear-viewed in the direction of extension according to arrow 19a—end area 24a with the second transmitting and/or receiving unit 62, and the carriage 15a in the opposite rear-viewed against the direction of extension according to arrow 19a—end area 25a with a fourth transmitting and/or receiving unit 68. The intermediate carriage 21a, 21b is additionally provided with a third transmitting and/or receiving unit 69. The second and the fourth transmitting and/receiving units 62 and 68, respectively, are each formed by a coil 65 mounted on a ferromagnetic core 64. The core 64 of the second transmitting and/or receiving unit 62 is secured on the intermediate carriage 21a, and the core 64 of the fourth transmitting and/or receiving unit 68 on the outer carriage 15a. The third transmitting and/or receiving unit 69 is formed by a conductor loop 70, which is connected to the coil 65 of the second transmitting and/or receiving unit 62.

The transmitting and/or receiving units 61, 62, 68 and 69 are again structured in such a way that signals and electrical energy can be wirelessly transmitted simultaneously.

If the telescopic push arm 11a, 11b can be extended in both directions with respect to the lifting platform 8, the intermediate carriage 21a, 21b and the carriage 15a, 15b, is additionally equipped with a transmitting and/or receiving unit 62a, 68a in the opposite end area 24a, 25b, respectively, as shown by a broken line. When the telescopic push arms 11a and 11b are extended to the right in the direction of extension 19a as shown, ac voltage is induced only in coils 65 (65a) of the second and the fourth transmitting and/or receiving units 62 and 68, respectively, arranged in the end areas 24a and, respectively, 25a. On the other hand, however, when the telescopic push arms 11a, 11b are extended to the left in the direction of extension 19b as shown by a broken line, ac voltage is induced only in the coils 65 (65a) of the second and the fourth transmitting and/or receiving units 62a, 68a arranged in the end areas 24b, 25b. The structure of the transmitting and/or receiving units 62a, 68a corresponds with the one of the transmitting and/or receiving unit 62.

The coils 65, (65a) of the fourth transmitting and/or receiving unit 68, 68a each are connected to the actuators 50a to 50d and/or sensors (not shown).

The conductor loop 63 and the coil 65 of the first transmitting and/or receiving unit 62, (62a) are electrically insulated against each other, but magnetically coupled to one another, so that the coil 65 is therefore permeated by the magnetic field generated by the conductor loop 63, through which the current is flowing. Likewise, the conductor loop 70 and the coil 65 of the fourth transmitting and receiving unit 68, (68a) are electrically insulated against each other, but magnetically coupled to one another, so that the magnetic coil 65 is therefore permeated by the magnetic field generated by the conductor loop 70, through which current is flowing.

FIG. 14 shows a further embodiment of the telescopic push arms 11a and 11b for the load-receiving device 9. As already described in detail above, said telescopic arms each comprise the support frame 14a, 14b, the outer carriage 15a, 15b, as well as the intermediate carriages 21a, 21b; 25a, 26b, respectively, arranged between said frames and carriages. In addition, each telescopic push arm 11a, 11b is equipped with the transmission means 20 for feeding electrical energy and/or transmitting signals to the actuators 50a to 50d and/or to sensors (not shown), said transmission means comprising the transmitting and/or receiving units 61, 62, (62a), 68, (68a), 69, 71, (71a). The support frames 14a, 14b are equipped with the first transmitting and/or receiving unit 61, which is formed by the conductor loop 63 connected to the interface 52.

If the telescopic push arms 11a and 11b can be extended only unilaterally, the first carriage 21, 21b disposed adjacent to the support frame 14a provided in its opposite, rear-viewed in the direction of extension according to arrow 19a—end range 24a with the second transmitting and/or receiving unit 62; the second intermediate carriage 26a, 26b neighboring on the carriage 15a in its opposite rear-viewed against the direction of extension according to arrow 19a—end area 28a with the fourth transmitting and/or receiving unit 68; and the carriage 15a 15b in its opposite rear-viewed in the direction of extension according to arrow 19a—end area 25a with a sixth transmitting and/or receiving unit 71.

The first intermediate carriage 21a, 21b is additionally equipped with a third transmitting and/or receiving unit 69, and the second intermediate carriage 26a, 26b additionally with a fifth transmitting and/or receiving unit 72. The first, third and fifth transmitting and/or receiving units are formed by the conductor loops 63, 70 and 73, respectively. Said conductor loops 63, 70 and 73 each substantially extend over the entire length of the support frame 14a, 14b, as well as of the first and second intermediate carriage 21a, 21b; 26a, 26b. The conductor loop 70 is again connected to the coil 65 of the second transmitting and/or receiving unit 62, and the conductor loop 73 to the coil 65 of the fourth transmitting and/or receiving unit 68.

The core 64 (64a) with the coil 65 (65a) of the second transmitting and/receiving unit 62 (62a) mounted thereon is secured on the first intermediate carriage 21a, 21b. The core 64 (64a) with the coil 65 (65a) of the fourth transmitting and/or receiving unit 68 mounted thereon is secured on the second intermediate carriage 26a, 26b. The core 64 (64a) with the coil 65 (65a) of the sixth transmitting and/or receiving unit 71 mounted thereon is secured on the carriage 15a, 15b.

If the telescopic push arms 11a, 11b are capable of extending in both directions with respect to the lifting platform 8, the intermediate carriages 21a, 21b; 26a, 26b, and also the outer carriages 15a, 15b are additionally equipped with a transmitting and/or receiving unit 62a, 68a 71 a also in each of the further end area 24b, 28b, 25b, as indicated by broken lines. When the telescopic push arms 11a, 11b are extended to the right in the direction of extension indicated by arrow 19a, ac voltage is induced only in the coils 65 (65a) of the second, fourth and sixth transmitting and/or receiving units 62, 68, 71, respectively, arranged in the end areas 24a, 28a, 25a, respectively, whereas when the direction of extension is reversed as indicated by arrow 19b and broken lines, ac voltage is induced only in the coils 65 (65a) of the second, fourth and sixth transmitting and/or receiving units 62a, 68a, 71a arranged in the end area 24b, 28b, 25b, respectively.

If energy and/or signals are transmitted via separate transmission lines as described in connection with FIG. 12, the transmitting and/or receiving units 61, 69, 72 each comprise two separate conductor loops 63, 63a, 70, 70a, 73, 73a, and the transmitting and/or receiving units 62, 68, 71 each have two coils 65, 65a mounted on one or two cores 64, 64a.

The coils 65 (65a) of the sixth transmitting and/or receiving units 71, 71a each are connected to the actuators 50a to 50d and/or sensors (not shown).

Furthermore, the conductor loop 73 and the coil 65 of the sixth transmitting and/or receiving unit 71, (71a) are electrically insulated against one another, but magnetically coupled with each other; therefore, the coil 65 is permeated by the magnetic field generated by the conductor loop 73 flowed through by current.

As opposed to the energy and/or signal or data transmission by means of substantially inductive elements described heretofore, energy and/or signals or data can be transmitted as well with substantially capacitive elements, e.g. capacitors. Instead of the windings of the coil 65 (65a) mounted on a ferromagnetic core 64 (64a), the support frames 14a, 14b, the intermediate carriages 21a, 21b, 26a, 26, and the carriages 15a, 15b are equipped in that case with, for example a first plate of a plate capacitor serving as the transmitting and/or receiving unit. The corresponding transmitting and/or receiving unit on the adjacent intermediate carriage 21a, 21b; 26a, 26, or carriage 15, 15b serves as the corresponding second plate of the plate capacitor. As voltage is being applied to the capacitor so formed, an electrical field is generated between said capacitor plates, which, entirely analogous to the electromagnetic field described above, can be used for transmitting energy and/or signals or data.

Likewise, wireless transmission of energy and/or signals or data between the transmitting and/or receiving units secured on the support frame 14a, 14b, intermediate carriage 21a, 21b, 26a, 26, and carriage 15, 15b in the manner described above, is possible also by optical means, e.g. by means of laser or infrared, and/or by means of radio transmission.

Finally, it is pointed out that energy and/or signals can be transmitted not only from the interface 52 to the actuators 50a to 50e and/or sensors, but also from the actuators 50a to 50e and/or sensors to the interface 52. Bidirectional transmission of energy and/or signals is therefore possible as well. Likewise, the transmitting and/or receiving units 61, 62, (62a); 68 (68a), 69; 71, (71a), 72 alternately arranged between the support frame 14a, 14b, intermediate carriage 21a, 21b 26a, 26b, and carriage 15a, 15b, can be arranged also in a reversed sequence. For example, in case the carriage 15a, 15b can be extended in only one direction, the support frame 14a, 14b may have the transmitting and/or receiving unit 62 (62a) in one of its end areas 27a, 27b, or if the carriage 15a, 15b can be extended in both directions, in both of said end areas, whereas the carriage 15, 15b is equipped with the transmitting and/or receiving unit 61 (61a).

The exemplified embodiments show possible design variations of the application of a telescopic push arm 11a, 11b, whereby it is noted herewith that the invention is not limited to the design variations specifically shown herein, but that various combinations of the individual design variations among each other are possible as well, and that owing to the instruction for technical execution of the present invention, such variation possibility falls within the scope of the skill of the expert engaged in the present technical field. Therefore, all conceivable design variations feasible by combining individual details of the design variations shown and described herein, are jointly covered by the scope of protection.

It is finally not for the sake of good order that in the interest of superior understanding of the structure of the telescopic push arm 11a, 11b, the latter and its components are partly represented untrue to scale and/or enlarged and/or reduced.

### LIST OF REFERENCE NUMBERS

1 Storage system
2 Aisle
3a Shelf storage system
3b Shelf storage system
4 Rail
5 Double arrow
6 Shelf-servicing equipment
7 Mast
8 Lifting platform
9 Load-receiving device
10 Double arrow
11a Telescopic push arm
11b Telescopic push arm
12 Auxiliary loading means
13a Driving element
13b Driving element
13c Driving element
13d Driving element
13e Driving element
13f Driving element
14a Support frame
14b Support frame
15a Carriage
15b Carriage
16 Sliding-line arrangement
17 Sliding contact
17a Sliding contact
17b Sliding contact
18 Sliding-body arrangement
18a Sliding-body arrangement
18b Sliding-body arrangement
18c Sliding-body arrangement
18d Sliding-body arrangement
18e Sliding-body arrangement
19a Direction of extension
19b Direction of extension
20 Transmission means
21a Intermediate carriage
21b Intermediate carriage
22a Sliding-line arrangement
22b Sliding-line arrangement
23 Sliding-line arrangement
24a End area of intermediate carriage
24b End area of intermediate carriage
25a End area of carriage
25b End area of carriage
26a Intermediate carriage
26b Intermediate carriage
27a End area of support frame
27b End area of support frame
28a End area of intermediate carriage
28b End area of intermediate carriage
29a Guide component
30a Frame component
32a Vertical and/or lateral guiding track
32b Vertical and/or lateral guiding track
34a Mounting
35 Guide component
36a Mounting
37a Vertical and/or lateral guiding track
37b Vertical and/or lateral guiding track
38a Vertical and/or lateral guiding track
38b Vertical and/or lateral guiding track
40a Guide component
40b Guide component
41a Mounting
42a Vertical and/or lateral guiding track
42b Vertical and/or lateral guiding track
43a Vertical and/or lateral guiding track
43b Vertical and/or lateral guiding track
44a Guide component
45a Mounting
46 Length of sliding-line arrangement
48 Length of sliding contact
50a Actuator
50b Actuator
50c Actuator
50d Actuator
51 Sensor
52 Interface
53 Body made of basic insulation material
54 Sliding line
55 Sliding body
56 Gap spacing
57a Side wall
57b Side wall
60 Transmission means
61 Transmitting and/or receiving unit
62 Transmitting and/or receiving unit
62a Transmitting and/or receiving unit
63 Conductor loop
63a Conductor loop
64 Core
64a Core
65 Coil
65a Coil
66 Feed line
67 Return line
68 Transmitting and/or receiving unit
68a Transmitting and/or receiving unit
69 Transmitting and/or receiving unit
70 Conductor loop
71 Transmitting and/or receiving unit
71a Transmitting and/or receiving unit
72 Transmitting and/or receiving unit
73 Conductor loop

1. A telescopic push arm (11a, 11b) for a load-receiving device (9) arranged on a vertically and/or horizontally adjustable lifting platform (8) of a conveying vehicle, for storing an auxiliary loading means (12) in and removing it from a shelf storage system (3a, 3b), with a support frame (14a, 14b) and at least one carriage (15a, 15b) adjustable relative to said support frame, said carriage (15a, 15b being extendible in both directions with respect to the support frame (14a, 14b), and with at least one servo-drive (50a to 50f) and/or at least one sensor (51), whereby the servo-drive (50a to 50f) and/or the sensor (51) are connected to an electrical interface (52) arranged within the area of the support frame (14a, 14b) via a transmission means (20) for transmitting electrical energy and/or electrical signals, wherein the transmission means (20) for transmitting electrical energy and/or electrical signals is formed by at least one sliding-line arrangement (16; 23a, 23b; 23) and at least two sliding-body arrangements (18 to 18e) provided structurally separated spaced from one another in the direction of extension (19a, 19b) of the carriage (15a, 15b), whereby the sliding-line arrangement (16; 22a, 22b; 23) and the sliding-body arrangements (18 to 18e) are arranged between the support frame (14a, 14b) and the carriage (15a, 15b); that the spacing between the sliding-body arrangements (18 to 18e) is smaller than the maximum length of the carriage (15a, 15b) and/or of the support frame (14a, 14b); and that for transmitting energy and/or signals from the interface (52) to the servo-drive (50a to 50f) and/or the sensor (51), and reversely, if necessary, at least one electrical sliding contact (17, 17a, 17b) is formed between the sliding-line arrangement (16; 22a, 22b; 23) and the sliding-body arrangement (18 to 18e).

2. The telescopic push arm according to claim 1, wherein the sliding-line arrangement (16) is arranged on the support frame (14a, 14b) and the sliding-body arrangements (18a, 18b) are arranged on the carriage (15a, 15b).

3. The telescopic push arm according to claim 1, wherein the sliding-line arrangement (16) is arranged on the carriage (15a, 15b) and the sliding-body arrangements (18a, 18b) are arranged on the support frame (14a, 14b).

4. The telescopic push arm according to claim 1, wherein the carriage (15a, 15b) is provided with at least one sliding-body arrangement (18a, 18b) in each of its face-side end areas (25a, 25b) opposing each other.

5. The telescopic push arm according to claim 1, wherein the support arm (14a, 14b) is provided with at least one sliding-body arrangement (18a, 18b) in each of its face-side end areas (27a, 27b) opposing each other.

6. The telescopic push arm according to claim 1, wherein at least one intermediate carriage (21a, 21b) is arranged between the support frame (14a, 14b) and the carriage (15a, 15b), whereby the carriage (15a, 15b) and the intermediate carriage (21a, 21b) are adjustable relative to the support frame (14a, 14b), and the carriage (15a, 15b) and the intermediate carriage (21a, 21b) are adjustable relative to one another, and whereby the intermediate carriage (21a, 21b), the carriage (15a, 15b) and the support frame (14a, 14b) are guided among one another; that a first sliding-line arrangement (22a) and two sliding-body arrangements (18, 18c) are arranged between the support frame (14a, 14b) and the intermediate carriage (21a, 21b); and that a second sliding-line arrangement (22b) and two further sliding-body arrangements (18a, 18b) are arranged between the carriage (15a, 15b) and the intermediate carriage (21a, 21b).

7. The telescopic push arm according to claim 6, wherein the support frame (14a, 14b) and the carriage (15a, 15b), in their face-side end areas (27a, 27b, 25a, 25b) opposing each other, each are provided with a sliding-body arrangement 18, 18c, 18a, 18b), and the intermediate carriage (21a, 21b) is provided with a sliding-line arrangement (22a, 22b) on each of its sides facing the support frame (14a, 14b) and the carriage (15a, 15b), whereby at least one electrical sliding contact (17, 17a) is formed between each sliding-line arrangement (22a, 22b) and sliding-body arrangement (18, 18c, 18a, 18b), and the sliding-line arrangements (22a, 22b) on the intermediate carriage (21a, 21b) are electrically conductively connected to each other.

8. The telescopic push arm according to claim 6, wherein the support frame (14a, 14b) and the carriage (15a, 15b) each are provided with a sliding-line arrangement (22a, 22b) on sides facing each other, and the intermediate carriage (21a, 21b), in its face-side end areas (24a, 24b) opposing each other, is provided with a sliding-body arrangement (18, 18c, 18a, 18b) on each of its sides facing the support frame (14a, 14b) and the carriage (15a, 15b), whereby an electrical sliding contact (17, 17a) is formed between each sliding-line arrangement (22a, 22b) and sliding-body arrangement (18, 18c, 18a, 18b), and the sliding-body arrangements (18, 18c, 18a, 18b) are electrically conductively connected to each other.

9. The telescopic push arm according to claim 1, wherein two intermediate carriages (21a, 21b, 26a, 26b) are arranged between the support frame (14a, 14b) and the carriage (15a, 15b), whereby the intermediate carriages (21a, 21b, 26a, 26b) are adjustable relative to the support frame (14a, 14b) and the carriage (15a, 15b), and the intermediate carriages (21a, 21b, 26a, 26b) are adjustable relative to each other, and whereby the intermediate carriages (21a, 21b, 26a, 26b), the carriage (15a, 15b) and the support frame (14a, 14b) are guided among one another; that a first sliding-line arrangement (16) and two first sliding-body arrangements (18, 18) are arranged between the support frame (14a, 14b) and the first intermediate carriage (21a, 21b); and that a second sliding-line arrangement (22a) and two second sliding-body arrangements (18a, 18c) are arranged between the first and the second intermediate carriage (21a, 21b, 26a, 26b), and a third sliding-line arrangement (22b) and two third sliding-body arrangements (18b, 18c) are arranged between the second intermediate carriage (26a, 26b) and the carriage (15a, 15b).

10. The telescopic push arm according to claim 9, wherein the support frame (14a, 14b) has the sliding-line arrangement (16), and the second intermediate carriage (26a, 26b) neighboring on the carriage (15a, 15b) has a sliding-line arrangement (22a, 22b) on each of its sides facing the support frame (14a, 14b) and the carriage (15a, 15b); and that the first intermediate carriage (21a, 21b) neighboring on the support frame (14a, 14b) is provided with a sliding-body arrangement (18, 18d) on each of its sides facing the support frame (14a, 14b) and the carriage (15a, 15b) in each of the face-side end areas (24a, 24b) opposing each other, and the carriage (15a, 15b) is provided with a sliding-body arrangement (18b, 18e) in each of the face-side end areas (25a, 25b) opposing each other, whereby an electrical sliding contact (17, 17a, 17b) is formed between each sliding-line arrangement (16, 22a, 22b) and sliding-body arrangement (8, 18a to 18e), and the sliding-body arrangements (18, 18a, 18c, 18d) on the first intermediate carriage (21a, 21b) and also the sliding-line arrangements (22a, 22b) on the second intermediate carriage (26a, 26b) are electrically conductively connected to each other.

11. The telescopic push arm according to claim 9, wherein the carriage (15a, 15b) has the sliding-line arrangement (16) on its side facing the support frame (14a, 14b), and the first intermediate carriage (21a, 21b) neighboring on the support frame (14a, 14b) has a sliding-line arrangement (22a, 22b) on each of its sides facing the support frame (14a, 14b) and the carriage (15a, 15b); that the support frame (14a, 14b) is provided with a sliding-body arrangement (18, 18d) in each of the face-side end areas (27a, 27b) opposing each other; and that the second intermediate carriage (26a, 26b) neighboring on the carriage (15a, 15b) is provided with a sliding-body arrangement (18a, 18c) on each of is sides facing the support frame (14a, 14b), and the carriage (15a, 15b) in each of the face-side end areas opposing one another, whereby an electrical sliding contact (17, 17a, 17b) is formed between each sliding-line arrangement (16, 22a, 22b) and sliding-body arrangement (18, 18d, 18a, 18c), and the sliding-line arrangements (16, 22a, 22b) on the first intermediate carriage (21a, 21b) and also the sliding-body arrangements (18, 18d, 18a, 18c) on the second intermediate carriage (26a, 26b) are electrically conductively connected to each other.

12. A telescopic push arm (11a, 11b) for a load-receiving device (9) arranged on a vertically and/or horizontally adjustable lifting platform (8) of a conveying vehicle, for storing or removing an auxiliary loading means (12) in or from a shelf storage system (3a, 3b), with a support frame (14a, 14b) and at least one carriage (15a, 15b) adjustable relative to said support frame, said carriage (15a, 15b) being extendible in one direction with respect to the support frame (14a, 14b), and provided with at least one servo-drive (50a to 50d) and/or at least one sensor (51), whereby the servo-drive (50a to 50d) and/or the sensor (519 are connected to an electrical interface (52) via a transmission means (20) for transmitting electrical energy and/or electrical signals, said interface being arranged within the area of the support frame (14a, 14b), wherein the transmission means (20) for transmitting electrical energy and/or electrical signals is formed by at least one sliding-line arrangement (16; 22a, 22b; 23) and at least one sliding-body arrangement (18; 18a; 18b), whereby the sliding-line arrangement (16; 22a, 22b; 23) and the sliding-body arrangement (18; 18a; 18b) are arranged between the support frame (14a, 14b) and the carriage (15a, 15b); and that at least one electrical sliding contact (17; 17a; 17b) is formed between the sliding-line arrangement (16; 22a, 22b; 23) and the sliding-body arrangement (18; 18a; 18b) for transmitting energy and/or signals from the interface (52) to the servo-drive (50a to 50d) and/or the sensor (51), and reversely, if necessary.

13. The telescopic push arm according to claim 12, wherein the sliding-line arrangement (16) is arranged on the support frame (14a, 14b) and the sliding-body arrangement (18) on the carriage (15a, 15b).

14. The telescopic push arm according to claim 12, wherein the sliding-line arrangement (16) is arranged on the carriage (15a, 15b), and the sliding-body arrangement (18) on the support frame (14a, 14b).

15. The telescopic push arm according to claim 12, wherein the carriage (15a, 15b) is provided with the sliding-body arrangement (18) in its trailing end area (25a; 25b) with respect to the direction of extension (19a; 19b).

16. The telescopic push arm according to claim 12, wherein the support frame (14a, 14b) is provided with the sliding-body arrangement (18) at least in its front end area (27a; 27b) viewed in the direction of extension (19a; 19b) of the carriage (15a, 15b).

17. The telescopic push arm according to claim 12, wherein at least one intermediate carriage (21a, 21b) is arranged between the support frame (14a, 14b) and the carriage (15a, 15b), whereby the carriage (15a, 15b) and the intermediate carriage (21a, 21b) are adjustable relative to the support frame (14a, 14b), and the carriage (15a, 15b) and the intermediate carriage (21a, 21b) are adjustable relative to one another, and whereby the intermediate carriage (21a, 21b), the carriage (15a, 15b) and the support frame (14a, 14b) are guided among one another; and that a first sliding-line arrangement (16; 22a) and a first sliding-body arrangement (18) are arranged between the support frame (14a, 14b) and the intermediate carriage (21a, 21b), and the second sliding-line arrangement (22b) and a further sliding-body arrangement (18a) are arranged between the carriage (15a, 15b) and the intermediate carriage (21a, 21b).

18. The telescopic push arm according to claim 17, wherein the intermediate carriage (21a, 21b) has a sliding-line arrangement (22a, 22b) on each of its sides facing the support frame (14a, 14b) and the carriage (15a, 15b), and that the carriage (15a, 15b) is provided with a sliding-body arrangement (18a, 18) in its end area (25a; 25b) disposed opposite to the direction of extension (19a, 19b), and the support frame (14a, 14b) with a sliding-body arrangement (18a, 18) in its front end area (27a; 27b) viewed in the direction of extension (19a, 19b) of the carriage (15a, 15b), whereby an electrical sliding contact (17a, 17) is formed between each sliding-line arrangement (22a, 22b) and each sliding-body arrangement (18a, 18), and the sliding-line arrangements (22a, 22b) on the intermediate carriage (21a, 21b) are electrically conductively connected to each other.

19. The telescopic push arm according to claim 17, wherein the support frame (14a, 14b) and the carriage (15a, 15b) each have a sliding-line arrangement (16, 23) on their sides facing one another, and that the intermediate carriage (21a, 21b) is provided on its side facing the support frame (14a, 14b) with a sliding-body arrangement (18, 18a) in the end area (24a; 24b) trailing in the direction of extension (19a; 19b) of the carriage (15a, 15b), as well as on its side facing the carriage (15a, 15b) in its end area (24a; 24b) leading in the direction of extension (19a; 19b) of the carriage (15a, 15b), whereby an electrical sliding contact (17, 17a) is formed between each sliding-line arrangement (16, 23) and each sliding-body arrangement (18, 18a), and the sliding-body arrangements (18, 18a) on the intermediate carriage (21a, 21b) are electrically conductively connected to each other.

20. The telescopic push arm according to claim 12, wherein two intermediate carriages (21a, 21b, 26a, 26b) are arranged between the support frame (14a, 14b) and the carriage (15a, 15b), whereby the intermediate carriages (21a, 21b, 26a, 26b) are adjustable in relation to the support frame (14a, 14b), and the carriages (15a, 15b) and the intermediate carriage (21a, 21b, 26a, 26b) are adjustable relative to each other, and whereby the intermediate carriages (21a, 21b, 26a, 26b), the carriage (15a, 15b) and the support frame (14a, 14b) are guided among one another; and that the first sliding-line arrangement (16) and the first sliding-body arrangement (18) are arranged between the support frame (14a, 14b) and the first intermediate carriage (21a, 21b); the second sliding-line arrangement (22a) and the second sliding-body arrangement (18a) between the first and the second intermediate carriages (21a, 21b); and the third sliding-line arrangement (22b) and the third sliding body arrangement (18b) between the second intermediate carriage (21a, 21b) and the carriage (15a, 15b).

21. The telescopic push arm according to claim 20, wherein the support frame (14a, 14b) has the sliding-line arrangement (16), and the second intermediate carriage (26a, 26b) neighboring on the carriage (15a, 15b) has a sliding-line arrangement (22a; 22b) on each of its sides facing the support frame (14a, 14b) and the carriage (15a, 15b); that the first intermediate carriage (21a, 21b) neighboring on the support frame (14a, 14b) is provided with a sliding-body arrangement (18, 18a) both in its end area (24a; 24b) trailing in the direction of extension (19a; 19b), as well as on its side facing the carriage (15a, 15b) in its front end area viewed in the direction of extension (19a, 19b); and that the carriage (15a, 15b) is provided with a sliding-body arrangement (18b) in its trailing end area (25a; 25b) with respect to the direction of extension (19a; 19b), whereby an electrical sliding contact (17, 17a, 17b) is formed between each sliding-line arrangement (16, 22a, 22b) and each sliding-body arrangement (18, 18a, 18b), and the sliding-body arrangements (18, 18a) on the first intermediate carriage (21a, 21b), and also the sliding-line arrangements (16, 22a, 22b) on the second intermediate carriage (26a, 26b) each are electrically conductively connected to one another.

22. The telescopic push arm according to claim 20, wherein the carriage (15a, 15b) has the sliding-line arrangement (16) on its side facing the support frame (14a, 14b), and the first intermediate carriage (21a, 21b) neighboring on the support frame (14a, 14b) has a sliding-line arrangement (22a, 22b) on each of its sides facing the support frame (14a, 14b) and the carriage (15a, 15b); that the support frame (14a, 14b) is provided in its leading end area (27a; 27b) in the direction of extension (19a; 19b) of the carriage (15a, 15b) with a sliding-body arrangement (18); and that the second intermediate carriage (26a, 26b) neighboring on the carriage (15a, 15b) with a sliding-body arrangement (18a, 18b) both on its side facing the support frame (14a, 14b), in the end area trailing in the direction of extension (19a; 19b) of the carriage (15a, 15b), and its side facing the carriage (15a, 15b), in the front end area leading in the direction of extension (19a; 19b) of the carriage (15a, 15b), whereby an electrical sliding contact (17, 17a, 17b) is formed between each sliding-line arrangement (16; 22a, 22b) and each sliding-body arrangement (18, 18a, 18b), and the sliding-body arrangements (18a, 18b) on the second intermediate carriage (26a, 26b) are electrically conductively connected to each other.

23. The telescopic push arm according to claim 1, wherein the length (46) of the sliding-line arrangement (16; 22a, 22b; 23) approximately corresponds with the length of the support frame (14a, 14b), the intermediate carriage (21a, 21b, 26a, 26b), or of the carriage (15a, 15b).

24. The telescopic push arm according to claim 1, wherein the length (48) of the sliding contact (17, 17a, 17b) of the sliding-body arrangement (18 to 18e) between the sliding-line arrangement (16; 22a, 22b; 23) and the sliding body arrangement (18 to 18e) amounts to a fraction of the length (46) of the sliding-line arrangement (16; 22a, 22b; 23).

25. The telescopic push arm according to claim 1, wherein the sliding-line arrangement (16; 22a, 22b; 23) is formed by a plurality of sliding lines (54) disposed parallel next to one another, and that each of the sliding-body arrangements (18 to 18e) is formed by a plurality of spring-actuated sliding bodies (55), particularly carbon brushes.

26. A telescopic push arm (11a, 11b) for a load-receiving device (9) mounted on a vertically and/or horizontally adjustable lifting platform (8) for storing an auxiliary loading means (12) in or removing the latter from a shelf storage system (3a, 3b), with a support frame (14a, 14b) and at least one carriage (15a, 15b) adjustable relative to said support frame, said carriage (15a, 15b) being provided with at least one servo-drive (50a to 50f) and/or at least one sensor (51), whereby the servo-drive (50a to 50f) and/or sensor (51) are connected to an electrical interface (52) arranged within the area of the support frame (14a, 14b) via a transmission means (60) for transmitting electrical energy and/or electrical signals, wherein the transmission means (60) for transmitting electrical energy and/or electrical signals is formed by at least one first transmitting and/or receiving unit (61) and at least one second transmitting and/or receiving unit (62), said transmitting and/or receiving units (61, 62) being structurally separated from each other with a small spacing in between, and arranged between the support frame (14a, 14b) and the carriage (15a, 15b), as well as actively connected with each other; and that the energy and/or signals for the servo-drive (50a to 50f) and/or sensor (51) are transmitted from the interface (52) to connections of the servo-drive (50a to 50f) and/or sensor (51), and reversely, if necessary, via the transmitting and/or receiving units (61, 62) associated with one another, in a contactless, particularly electromagnetic way.

27. The telescopic push arm according to claim 26, wherein the first transmitting and/or receiving unit (61) is arranged on the support frame (14a, 14b), and the second transmitting and/or receiving unit (62) on the carriage (15a, 15b).

28. The telescopic push arm according to claim 26, wherein the first transmitting and/or receiving unit (61) is arranged on the carriage (15a, 15b) and the second transmitting and/or receiving unit (62) on the support frame (14a, 14b).

29. The telescopic push arm according to claim 26, wherein the support frame (14a, 14b) is provided with the first transmitting and/or receiving unit (61) at least in its front end area (27a; 27b viewed in the direction of extension (19a; 19b) of the carriage (15a, 15b).

30. The telescopic push arm according to claim 26, wherein the carriage (15a, 15b) is provided with the second transmitting and/or receiving unit (62) at least in its trailing end area (25a; 25b) viewed in the direction of extension (19a; 19b).

31. The telescopic push arm according to claim 26, wherein the at least one carriage (15a, 15b) is extendible in both direction with respect to the lifting platform (8), and provided with at least one second transmitting and/or receiving unit (62, 62a) in each of the end areas (25a, 25b) opposing one another in its longitudinal expanse.

32. The telescopic push arm according to claim 26, wherein the at least one carriage (15a, 15b) is extendible in both directions with respect to the lifting platform (8), and the support frame (14a, 14b) is provided with at least one first transmitting and/or receiving unit (61) in each of its end areas (27a, 27b) opposing each other.

33. The telescopic push arm according to claim 26, wherein the at least one intermediate carriage (21a, 21b) is arranged between the support frame (14a, 14b) and the carriage (15a, 15b), whereby the carriage (15a, 15b) and the intermediate carriage (21a, 21b) are adjustable relative to the support frame (14a, 14b), and the carriage (15a, 15b) and the intermediate carriage (21a, 21b) are adjustable relative to each other, and whereby the intermediate carriage (21a, 21b), the carriage (15a, 15b) and the support frame (14a, 14b) are guided among one another; and that a first and a second transmitting and/or receiving unit (61, 62) are arranged between the support frame (14a, 14b) and the intermediate carriage (21a; 21b), and a third and a fourth transmitting and/or receiving unit (69, 68) between the carriage (15a, 15b) and the intermediate carriage (21a, 21b), whereby the first and the second transmitting and/or receiving units (61, 62) and the third and the fourth transmitting and/or receiving units (69, 68) are actively connected with one another.

34. The telescopic push arm according to claim 33, wherein the support frame (14a, 14b) comprises the first transmitting and/or receiving unit (61); the intermediate carriage (21a, 21b) the second and the third transmitting and/or receiving units (62, 69); and the carriage (15a, 15b) the fourth transmitting and/or receiving unit (68), whereby the second and the fourth transmitting and/or receiving units (62, 68) of the intermediate carriage (21a, 21b) and carriage (15a, 15b) each are arranged in the opposite end areas (25a, 25b) viewed in the direction of their extension (19a; 19b), or the intermediate carriage (21a, 21b) and the carriage (15a, 15b) each have a second and a fourth transmitting and/or receiving unit (62, 68) in their two face-side end areas (24a, 24b, 25a, 25b) opposing each other.

35. The telescopic push arm according to claim 26, wherein two intermediate carriages (21a, 21b, 26a, 26b) are arranged between the support frame (14a, 14b) and the carriages (15a, 15b), whereby the intermediate carriage (21a, 21b, 26a, 26b) are adjustable relative to the support frame (14a, 14b) and the carriage (15a, 15b) and the intermediate carriages (21a, 21b, 26a, 26b) relative to each other, and whereby the intermediate carriages (21a, 21b, 26a, 26b), the carriage (15a, 15b) and the support frame (14a, 14b) are guided among one another; and that a first and second transmitting and/or receiving unit (61, 62) are arranged between the support frame (14a, 14b) and the first intermediate carriage (21a, 21b) neighboring one the support frame (14a, 14b); a third and fourth transmitting and/or receiving unit (69, 68) between the intermediate carriages (21a, 21b, 26a, 26b) ; as well as a fifth and sixth transmitting and/or receiving unit (72, 71) between the second intermediate carriage (26a, 26b) neighboring on the carriage (15a, 15b), and the carriage (15a, 15b), whereby the first and second transmitting and/or receiving units (61, 62) and the third and fourth transmitting and/or receiving units (69, 68), and the fifth and sixth transmitting and/or receiving units (72, 71) are actively connected with each other.

36. The telescopic push arm according to claim 35, wherein the support frame (14a, 14b) comprises the first transmitting and/or receiving unit (61); the first intermediate carriage (21a, 21b) the second and the third transmitting and/or receiving units (62, 69); the second intermediate carriage (21a, 21b) the fourth and the fifth transmitting and/or receiving units (68, 72); and the carriage (15a, 15b) the sixth transmitting and/or receiving unit (71), whereby the second, fourth and sixth transmitting and/or receiving units (62, 68, 71) of the intermediate carriage (21a, 21b) and carriage (15a, 15b) each are arranged in the end area (25a; 25b) of the latter trailing in the direction of extension (19a; 19b) of the carriage (15a, 15b), or the intermediate carriage (21a, 21b) and the carriage (15a, 15b) each have a second, fourth and sixth transmitting and/or receiving unit (62, 68, 71) in its two face-side end areas (25a, 25b) opposing each other.

37. The telescopic push arm according to claim 26, wherein the first, third and fifth transmitting and/or receiving units (61, 69, 72) each are formed by at least one conductor loop (63, 70, 73), and the second, fourth and sixth transmitting and/or receiving units (62, 68, 71) by at least one coil (65) mounted on at least one, particularly ferromagnetic core (64), whereby each conductor loop (63, 70, 73) and the coil (65) are magnetically coupled with one another, and the magnetic field generated in the conductor loop (63, 70, 73) flown through by current permeates the coil (65) associated with the conductor loop.

38. The telescopic push arm according to claim 26, wherein the first, third and fifth transmitting and/or receiving units (61, 69, 72) each are formed by two conductor loops (63, 63a, 70, 70a, 73, 73a), and the second, fourth and sixth transmitting and/or receiving units (62,68, 71) by two at least two coils (65, 65a) mounted on at least one open ferromagnetic core (64); that energy and signals are separately transmittable by means of the first conductor loop (63, 70, 73) and first coil (65), and the second conductor loop (63a, 70a, 73a) and coil (65a), respectively, whereby each conductor loop (63, 63a, 70, 70a, 73, 73a) and each coil (65) are magnetically coupled with each other, and the magnetic field generated in the conductor loop (63, 63a, 70, 70a, 73, 73a) flown through by current permeates the coil (65, 65a) associated with such conductor loop.

39. The telescopic push arm according to claim 37, wherein the conductor loop (63, 63a, 70, 70a, 73, 73a) approximately corresponds with the length of the support frame (14a, 4b) and the intermediate carriage (21a, 21b, 26a, 26b).

40. The telescopic push arm according to claim 36, wherein the length of the coil (65, 65a) approximately amounts a fraction of the length (46) of the conductor loop (63, 63a, 70, 70a, 73, 73a).

41. A load-receiving device (9) for receiving and delivering loads of auxiliary loading means (12) particularly for a conveying vehicle, e.g. a shelf-servicing device (6) of a storage system (1), with two telescopic push arms (11a, 11b) extending parallel to and spaced from each other, and synchronously extendible transversely to an aisle (2), wherein the telescopic push arms (11a, 11b) are formed according to claim 1.
